(19) United States
(12) Patent Application Publication
(10) Pub. No.: US 2007/0070278 A1
(43) Pub. Date: Mar. 29, 2007

(54) Liquid crystal display

(75) Inventors: Hee-Wook Do, Suwon-si (KR); Yoon-Sung Um, Yongin-si (KR); Hak-Sun Chang, Yongin-si (KR); Seung-Hoo Yoo, Seongnam-si (KR); Hyun-Wuk Kim, Yongin-si (KR); Ji-Won Sohn, Seoul (KR); Nak-Cho Choi, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/528,837

(22) Filed: Sep. 27, 2006

(30) Foreign Application Priority Data
Sep. 27, 2005 (KR) 10-2005-0089829

(51) Int. Cl. G02F 1/1337

(52) U.S. Cl. 349/129

(57) ABSTRACT

A liquid crystal display is provided, which includes a plurality of pixel electrodes, a common electrode facing the pixel electrodes, a liquid crystal display formed between the pixel electrodes and the common electrode, and a plurality of slope members formed on the common electrode and having a ridge and an inclined surface. The slope members include a plurality of pixel slope members facing the pixel electrodes and a plurality of connection slope members for connecting neighboring pixel slope members.

### CROSS-REFERENCE TO RELATED APPLICATION

This application claims priority to and the benefit of Korean Patent Application No. 10-2005-0089829 filed in the Korean Intellectual Property Office on Sep. 27, 2005, the entire contents of which are incorporated herein by reference.

### FIELD OF THE INVENTION

The present invention relates to a liquid crystal display.

### DESCRIPTION OF THE RELATED ART

A liquid crystal display (LCD) is one of the most widely used flat panel displays. An LCD includes two panels provided with field-generating electrodes such as pixel electrodes and a common electrode, and a liquid crystal (LC) layer interposed between the panels. The LCD displays images by applying voltages to the field-generating electrodes to generate an electric field in the LC layer, which determines the orientations of the LC molecules and their polarization with respect to incident light.

Among the LCDs, a vertical alignment (VA) mode LCD, which aligns LC molecules such that the long axes of the LC molecules are perpendicular to the panels in the absence of an electric field, is highlighted because of its high contrast ratio and wide reference viewing angle (defined as the viewing angle at which the contrast ratio is equal to 1:10 or as the limit angle for the inversion in luminance between the grays).

The wide viewing angle of the VA mode LCD can be realized by cutouts in the field-generating electrodes and protrusions on the field-generating electrodes. Since the cutouts and the protrusions can determine the tilt directions of the LC molecules, the tilt directions can be variously distributed by using the cutouts and the protrusions such that the reference viewing angle is widened.

Moreover, for the purposes of light efficiency, it is desirable that the tilted direction of the liquid crystal molecules form an angle of 45° with respect to the polarization direction of the polarizers. In addition, with the vertically aligned mode liquid crystal display, the polarizers are attached so that the polarization directions of the polarizers are parallel or perpendicular to the gate lines or the data lines. Therefore, the cutouts or the protrusions are disposed to extend in a direction with an angle of 45° with respect to the gate lines or the data lines.

However, when pixel electrodes in a vertically aligned mode liquid display are of rectangle shape and are parallel to the gate lines and the data lines, the electric field generated between the adjacent pixel electrodes disturbs the alignment of the liquid crystal molecules so that a phenomenon known as texture may occur reducing the light transmittance of the liquid crystal material.

In an attempt to reduce texture, it has been proposed to overlap a portion of a cutout of the common electrode with a side of the pixel electrode. However, this results in reducing the aperture ratio of the liquid crystal display.

### SUMMARY OF THE INVENTION

A liquid crystal display is provided having an increased aperture ratio and light transmittance which includes a plurality of pixel electrodes, a common electrode facing the pixel electrodes, a liquid crystal layer formed between the pixel electrodes and the common electrode, and a plurality of slope members formed on the common electrode and having a ridge and an inclined surface. The slope members include a plurality of pixel slope members facing the pixel electrodes and a plurality of connection slope members for connecting neighboring pixel slope members.

The pixel electrodes have a pair of first primary edges facing each other and a pair of second primary edges exhibiting a plurality of sawtooth shaped protrusions connected to the first primary edges. Each of the protrusions may advantageously include a first edge that has an angle comprising one of about 135° or more or about 45° or less with respect to the cutouts.

### BRIEF DESCRIPTION OF THE DRAWING

The present invention will become more apparent from a reading of the ensuing description, together with the drawing, in which:

FIG. 1 is a view showing a layout of a liquid crystal display according to an exemplary embodiment of the present invention;

FIG. 2 is a view showing a layout of the thin film transistor panel for the liquid crystal display of FIG. 1;

FIG. 3 is a view showing a layout of the common electrode panel for the liquid crystal display of FIG. 1;

FIG. 4 is a cross-sectional view showing the liquid crystal display taken along line IV-IV of FIG. 1;

FIG. 5 is a cross-sectional view showing the liquid crystal display taken along line V-V of FIG. 1;

FIGS. 6A and 6B are sectional views showing slope members according to an exemplary embodiment of the present invention;

FIG. 7 is a view showing a layout of a liquid crystal display according to an exemplary embodiment of the present invention;

FIG. 8 is a cross-sectional view showing the liquid crystal display taken along line VIII-VIII of FIG. 7;

FIG. 9 is a view showing a layout of a common electrode and a pixel electrode of FIG. 7;

FIG. 10 is a view showing a layout of a liquid crystal display according to an exemplary embodiment of the present invention;

FIG. 11 is a cross-sectional view showing the liquid crystal display taken along line XI-XI of FIG. 10;

FIG. 12 is an enlarged view showing a portion of the liquid crystal display of FIG. 10;

FIG. 13 is a view showing a layout of a liquid crystal display according to an exemplary embodiment of the present invention;

FIG. 14 is a cross-sectional view showing the liquid crystal display taken along line XVI-XVI of FIG. 13;

FIG. 15 is a cross-sectional view showing a liquid crystal display taken along line VIII-VIII of FIG. 7 according to an exemplary embodiment of the present invention;

FIG. 16 is a view showing a layout of a liquid crystal display according to an exemplary embodiment of the present invention;

FIG. 17 is an enlarged view showing a portion of the liquid crystal display of FIG. 16;

FIG. 18 is a cross-sectional view showing the liquid crystal display taken along line XVIII-XVIII of FIG. 16;

FIG. 19 is a cross sectional view showing the liquid crystal display taken along line XIX-XIX of FIG. 16;

FIG. 20 is a schematic equivalent circuit diagram of a pixel of the liquid crystal display shown in FIG. 16.

FIG. 21 is a view showing a layout of a liquid crystal display according to an exemplary embodiment of the present invention.

FIG. 22 is an enlarged view showing a portion of the liquid crystal display of FIG. 21;

FIG. 23 is a cross-sectional view showing the liquid crystal display taken along line XXIII-XXIII of FIG. 21.

FIG. 24 is a cross-sectional view showing the liquid crystal display taken along line XXIV-XXIV of FIG. 21;

FIG. 25 is a view showing a layout of a liquid crystal display according to an exemplary embodiment of the present invention;

FIG. 26 is an enlarged view showing a portion of the liquid crystal display of FIG. 25;

FIG. 27 is a cross-sectional view showing the liquid crystal display taken along line XXVII-XXVII of FIG. 25; and

FIG. 28 is a cross-sectional view showing the liquid crystal display taken along line XXI-XXX of FIG. 25.

### DESCRIPTION OF THE EXEMPLARY EMBODIMENTS

The present invention now will be described more fully hereinafter with reference to the accompanying drawing, in which preferred embodiments of the invention are shown. In the drawing, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

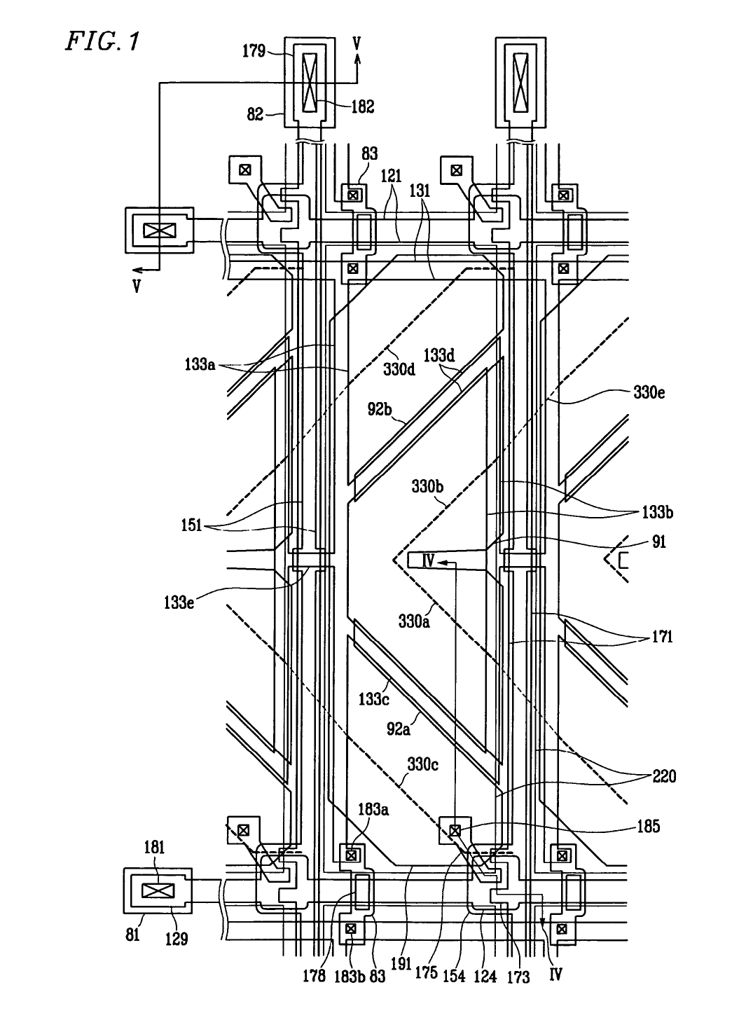

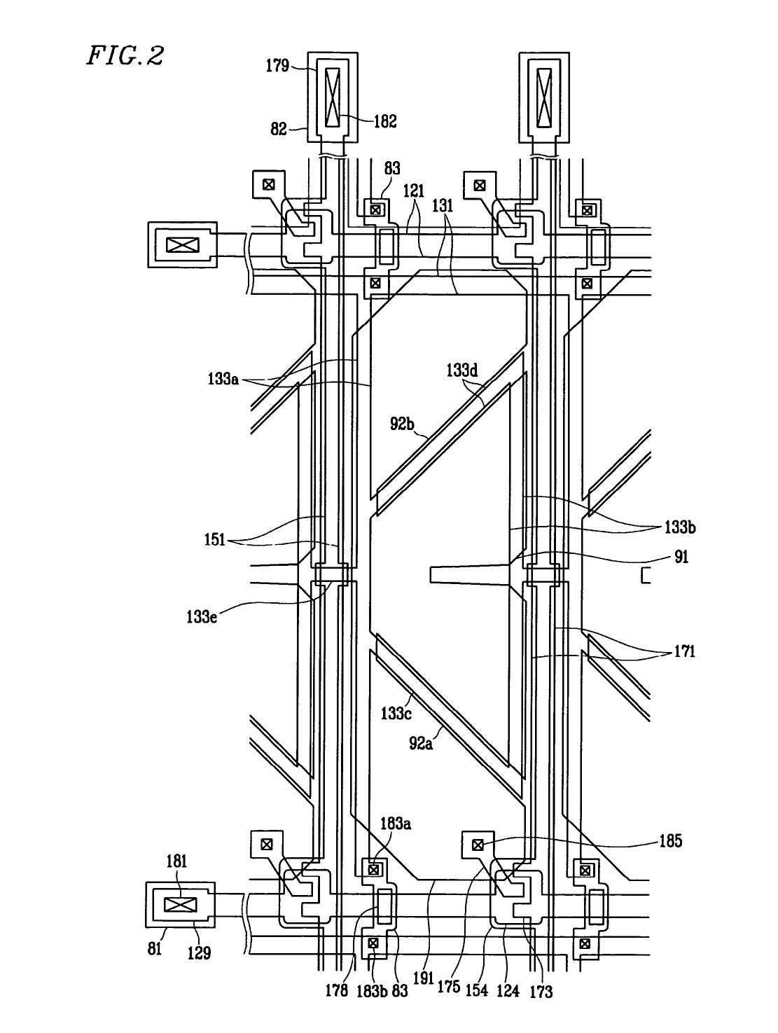

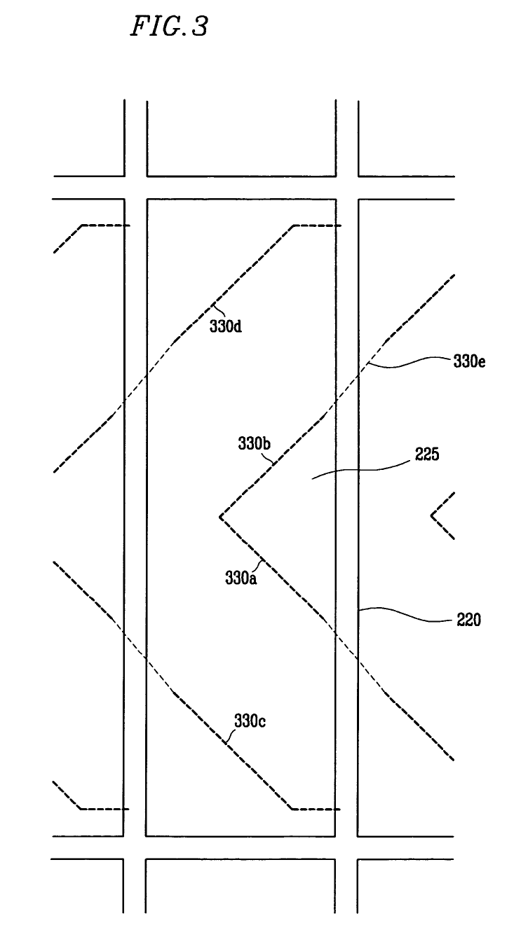

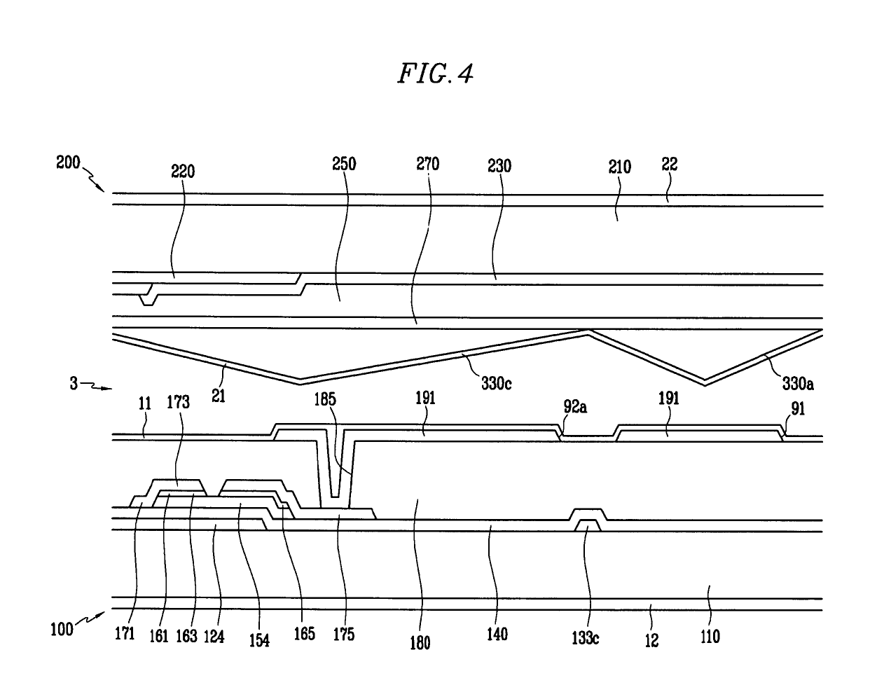

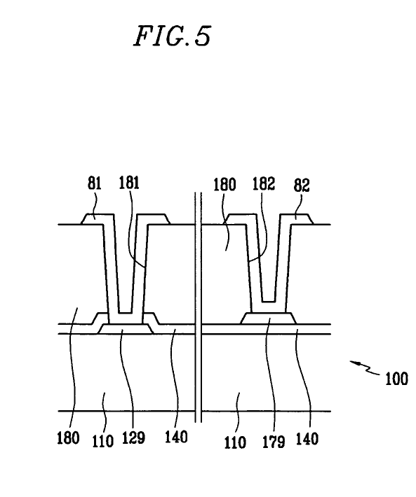

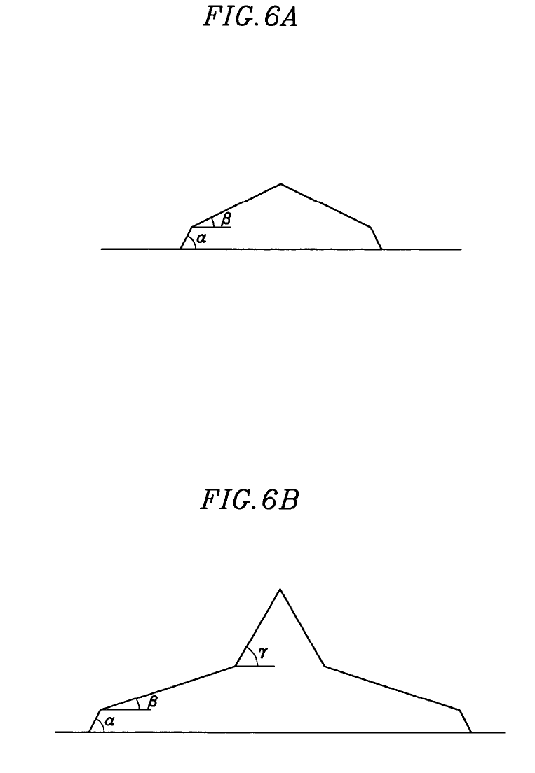

FIG. 1 is a view showing a layout of a liquid crystal display according to an exemplary embodiment of the present invention, FIG. 2 is a view showing a layout of a thin film transistor panel for the liquid crystal display of FIG. 1, FIG. 3 is a view showing a layout of a common electrode panel for the liquid crystal display of FIG. 1, FIG. 4 is a cross-sectional view showing the liquid crystal display taken along line IV-IV of FIG. 1, FIG. 5 is a cross-sectional view showing the liquid crystal display taken along line V-V of FIG. 1, and FIGS. 6A and 6B are sectional views showing slope members according to an exemplary embodiment of the present invention.

The TFT array panel 100 will now be described in detail with reference FIGS. 1, 2, 4, and 5. As shown, for example in FIG. 4, an LCD according to an embodiment of the present invention includes a TFT array panel 100, a common electrode panel 200, and an LC layer 3 interposed between the panels 100 and 200. As shown in FIG. 1, a plurality of gate lines 121 and a plurality of storage electrode lines 131 are formed on an insulating substrate 110 made of a material such as transparent glass.

Gate lines 121 for transmitting gate signals mainly extend in the transverse direction. Gate lines 121 include a plurality of gate electrodes 124 that protrude upwardly and downwardly and end portions 129 that have wide areas for connection to other layers or external driver circuits. A gate driver circuit that generates the gate signals may be mounted on a flexible printed circuit film attached on substrate 110. Alternatively, the gate driver circuit may be directly mounted on substrate 110, or it may be integrated with substrate 110. In the case where the gate driver circuit is integrated with substrate 110, gate lines 121 are extended to be directly connected to the gate driver circuit.

Storage electrode lines 131, to which predetermined voltages are applied, include stem lines that extend substantially in parallel to gate lines 121, a plurality of storage electrode sets of first, second, third, and fourth storage electrodes 133a, 133b, 133c, and 133d, and a plurality of connection portions 133e. Each of storage electrode lines 131 is disposed between adjacent two gate lines 121, and the stem line thereof is closer to the upper one of the two gate lines 121.

The first and second storage electrodes 133a and 133b extend in the longitudinal direction to face each other. First storage electrode 133a includes a fixed end connected to the stem line and a free end opposite to the fixed end, and the free end includes a protrusion. The third and fourth storage electrodes 133c and 133d extend in slanted directions substantially from about the central portion of first storage electrode 133a to the upper and lower ends of the second storage electrode 133b, respectively. The connection portions 133e are connected between adjacent storage electrode sets 133a-133d. However, various shapes and arrangements may be used for storage electrode lines 131.

Gate lines 121 and storage electrode lines 131 are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti or Ta. Gate lines 121 and storage electrode lines 131 may have a multi-layered structure including two films having different physical characteristics. One of the two films is preferably made of a low resistivity metal including an Al-containing metal, a Ag-containing metal, and a Cu-containing metal for reducing signal delay or voltage drop in gate lines 121 and storage electrode lines 131. The other film is preferably made of a material such as a Mo-containing metal, Cr, Ta or Ti, which has good physical, chemical, and electrical contact characteristics with other materials such as indium tin oxide (ITO) or indium zinc oxide (IZO). Good examples of the combination of the two films are a lower Cr film and an upper Al—Nd alloy film, and a lower Al (alloy) film and an upper Mo (alloy) film. However, gate lines 121 and storage electrode lines 131 may be made of various metals and conductive materials.

In addition, the lateral sides of gate lines 121 and storage electrode lines 131 are inclined relative to a surface of the substrate, and the inclination angle thereof ranges from about 30 to 80 degrees.

A gate insulating layer 140 preferably made of silicon nitride (SiNₓ) is formed on gate lines 121 and storage electrode lines 131.

A plurality of semiconductor stripes 151 preferably made of hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124. Semiconductor stripes 151 become wide near gate lines 121 and storage electrode lines 131 such that semiconductor stripes 151 cover large areas of gate lines 121 and storage electrode lines 131.

A plurality of ohmic contact stripes and islands 161 and 165 preferably made of silicide or n+hydrogenated a-Si heavily doped with an n-type impurity such as phosphorous are formed on semiconductor stripes 151. Each ohmic contact stripe 161 has a plurality of projections 163, and the projections 163 and the ohmic contact islands 165 are located in pairs on the projections 154 of semiconductor stripes 151.

The lateral sides of semiconductor stripes 151 and ohmic contacts 161 and 165 are inclined relative to a surface of the substrate, and the inclination angles thereof are preferably in a range of between about 30 to 80 degrees.

A plurality of data lines 171, a plurality of drain electrodes 175 separated from data lines 171, and a plurality of isolated metal pieces 178 are formed on ohmic contacts 161 and 165 and the gate insulating layer 140.

Data lines 171 for transmitting data voltages extend substantially in the longitudinal direction and cross gate lines 121 at right angles. Data lines 171 also intersect storage electrode lines 131 and the connections 133e such that each data line 171 is disposed between the first and the second storage electrodes 133a and 133b in adjacent sets of the branches 133a-133d of storage electrode lines 131. Each data line 171 includes a plurality of source electrodes 173 projecting toward the gate electrodes 124 and being curved like a crescent, and an end portion 179 having a large area for contact with another layer or an external driving circuit. A data driving circuit (not shown) for generating the data signals may be mounted on an FPC film (not shown), which may be attached to substrate 110, directly mounted on substrate 110, or integrated with substrate 110. Data lines 171 may extend to be connected to a driving circuit that may be integrated with substrate 110.

Drain electrodes 175 are separated from data lines 171 and disposed opposite the source electrodes 173 with respect to the gate electrodes 124. Each of drain electrodes 175 includes a wide end portion and a narrow end portion. The narrow end portion is partly enclosed by a source electrode 173.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

Metal pieces 178 are disposed on gate lines 121 near the end portions of first storage electrodes 133a.

Data lines 171, drain electrodes 175, and metal pieces 178 are preferably made of a refractory metal such as Cr, Mo, Ti, Ta, or alloys thereof. However, they may also have a multilayered structure including a low-resistivity film (not shown) and a good-contact film (not shown). A good example of the combination is a lower Mo film, an intermediate Al film, and an upper Mo film, as well as the above-described combinations of a lower Cr film and an upper Al—Nd alloy film and a lower Al film and an upper Mo film. However, data lines 171 and drain electrodes 175 may be made of various metals or conductors.

Data lines 171 and drain electrodes 175 have inclined edge profiles, and the inclination angles thereof range from about 30 to 80 degrees.

Ohmic contacts 161 and 165 are interposed only between the underlying semiconductor stripes 151 and the overlying data lines 171 and overlying drain electrodes 175 thereon, and reduce the contact resistance therebetween. Semiconductor stripes 151 include a plurality of exposed portions, which are not covered with data lines 171 and drain electrodes 175, such as portions located between the source electrodes 173 and drain electrodes 175. Although semiconductor stripes 151 are narrower than data lines 171 at most places, the width of semiconductor stripes 151 becomes large near gate lines 121 and storage electrode lines 131 as described above, to smooth the profile of the surface, thereby preventing disconnection of data lines 171.

A passivation layer 180 is formed on data lines 171, drain electrodes 175, the metal pieces 178, and the exposed portions of semiconductor stripes 151. Passivation layer 180 is preferably made of an inorganic insulator such as silicon nitride or silicon oxide, a photosensitive organic material having a good flatness characteristic, or an insulating material having a dielectric constant lower than 4.0 such as a-Si:C:O and a-Si:O:F formed by plasma enhanced chemical vapor deposition (PECVD). Passivation layer 180 may include a lower film of an inorganic insulator and an upper film of an organic insulator such that it takes the excellent insulating characteristics of the organic insulator while preventing the exposed portions of semiconductor stripes 151 from being damaged with the organic insulator.

Passivation layer 180 has a plurality of contact holes 182 and 185 exposing the end portions 179 of data lines 171 and the end portions of drain electrodes 175, respectively. Passivation layer 180 and the gate insulating layer 140 have a plurality of contact holes 181 exposing the end portions 129 of the gate lines 171, a plurality of contact holes 183a exposing portions of storage electrode lines 131 near the fixed end portions of the first storage electrodes 133a, and a plurality of contact holes 183a exposing the projections of the free end portions of the first storage electrodes 133a.

A plurality of pixel electrodes 191, a plurality of contact assistants 81 and 82, and a plurality of overpasses 83, which are preferably made of a transparent conductor such as ITO or IZO or a reflective conductor such as Ag or Al, are formed on passivation layer 180.

Pixel electrodes 191 are physically and electrically connected to drain electrodes 175 through the contact holes 185 such that pixel electrodes 191 receive data voltages from drain electrodes 175. Pixel electrodes 191 that are supplied with the data voltages generate electric fields in cooperation with a common electrode 270 of the opposing common electrode panel 200 supplied with a common voltage to determine the orientations of the liquid crystal molecules in liquid crystal layer 3. A pixel electrode 191 and the common electrode 270 form a capacitor referred to as a “liquid crystal capacitor,” which stores applied voltages after the TFT turns off.

A pixel electrode 191 overlaps a storage electrode line 131 including storage electrodes 133a and 133b. The pixel electrode 191 and a drain electrode 175 connected thereto and the storage electrode line 131 form an additional storage capacitor, which enhances the voltage storing capacity of the liquid crystal capacitor.

Each pixel electrode 191 is chamfered at its left corners, and the chamfered edges of the pixel electrode 191 make an angle of about 45 degrees with gate lines 121.

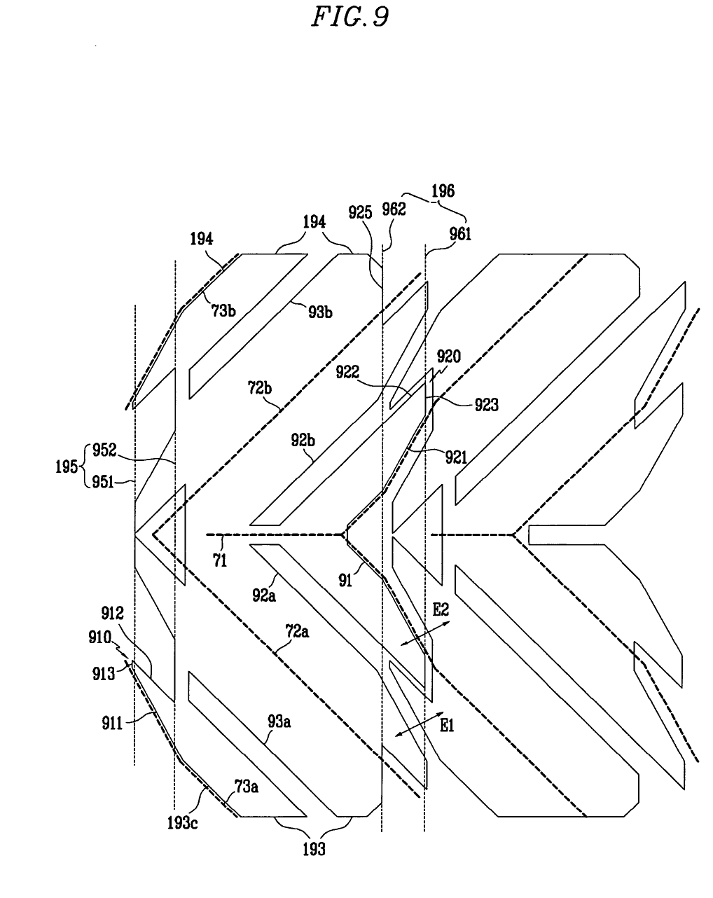

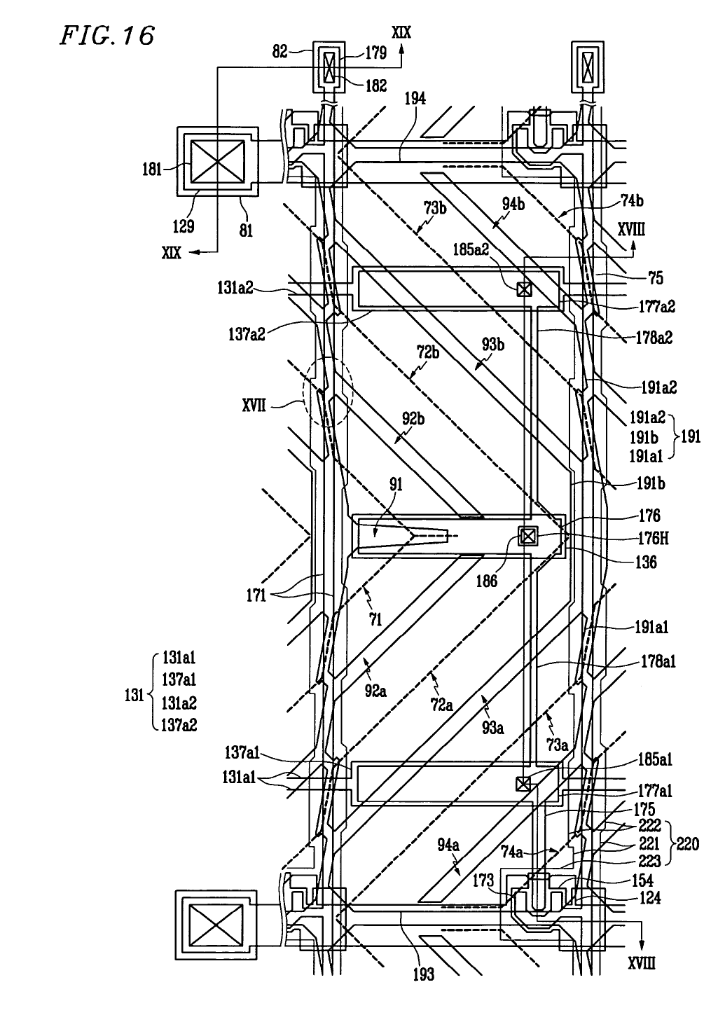

Referring, for example to FIGS. 9 and 16, each pixel electrode 191 has a lower cutout 92a, a center cutout 91, and an upper cutout 92b, which partition the pixel electrode 191 into a plurality of partitions. The cutouts 91-92b substantially have inversion symmetry with respect to an imaginary transverse line bisecting the pixel electrode 191.

The lower and the upper cutouts 92a and 92b obliquely extend from a right edge of the pixel electrode 191 near an upper right corner approximately to a center of a left edge of the pixel electrode 191, and overlap the third and fourth storage electrodes 133c and 133d. The lower and upper cutouts 92a and 92b they are disposed at lower and upper halves of the pixel electrode 191, respectively, can be divided by the imaginary transverse line. The lower and upper cutouts 92a and 92b make an angle of about 45 degrees to gate lines 121, and they extend substantially perpendicular to each other.

The center cutout 91 extends along the imaginary transverse line and has an inlet from the right edge of the pixel electrode 191, which has a pair of inclined edges substantially parallel to the lower cutout 92a and the upper cutout 92b, respectively.

Accordingly, the lower half of the pixel electrode 191 is partitioned into two lower partitions by the lower cutout 92a and the upper half of the pixel electrode 191 is also partitioned into two upper partitions by the upper cutout 92b. The number of partitions or the number of the cutouts is varied depending on design factors such as the size of pixels, the ratio of the transverse edges and the longitudinal edges of the pixel electrodes, the type and characteristics of the liquid crystal layer 3, and so on.

The overpasses 83 cross over gate lines 121 and are connected to the exposed projection of the fixed end portions of the first storage electrodes 133a and the exposed portions of storage electrode lines 131 through the contact holes 183b and 183a, respectively, which are disposed opposite each other with respect to gate lines 121. The overpasses 83 overlap the metal pieces 178, and they may be electrically connected to the metal pieces 178. Storage electrode lines 131 including the storage electrodes 133a-133d along with the overpasses 83 and the metal pieces 178 are used for repairing defects in gate lines 121, data lines 171, or the TFTs.

The contact assistants 81 and 82 are connected to the end portions the end portions 129 of gate lines 121 and the end portions 179 of data lines 171 through the contact holes 181 and 182, respectively. The contact assistants 81 and 82 protect the end portions 129 and 179 and complement the adhesion of the end portions 129 and 179 and external devices.

The description of the common electrode panel 200 follows with reference to FIGS. 1, 3, 4, and 5.

A light blocking member 220 called a black matrix for preventing light leakage is formed on an insulating substrate 210 made of a material such as transparent glass. The light blocking member 220 may include a plurality of openings 225 that face the pixel electrodes 191, and may have substantially the same planar shape as the pixel electrodes 191. Otherwise, the light blocking member 220 may include linear portions corresponding to data lines 171 and other portions corresponding to the TFTs. The light blocking member 220 may be made of a single layer of Cr, or a double layer of a Cr film and a Cr oxide film, and an organic layer including black pigment.

A plurality of color filters 230 are formed on the substrate 210, and they are disposed substantially in the areas enclosed by the light blocking member 220. The color filters 230 may extend substantially along the longitudinal direction along the pixel electrodes 191. The color filters 230 may represent one of the primary colors such as red, green, and blue, and the edges of color filters 30 may overlap each other.

An overcoat 250 for preventing the color filters 230 from being exposed and for providing a flat surface is formed on the color filters 230 and the light blocking member 220.

A common electrode 270 preferably made of a transparent conductive material such as ITO and IZO is formed on the overcoat 250.

A plurality of sets of slope members 331-333b preferably made of an insulator are formed on the common electrodes 270. The dielectric constant of the slope members 331-333b is preferably equal to or lower than that of the LC layer 3.

Each set of the slope members 330a-330e includes first to fourth slope members 331-333b opposing a pixel electrode 191, and a connection slope member 330e. Each of the slope members 330a-330d has principal edges parallel to edges of the cutouts 91-92b and the chamfered left edges of the pixel electrode 191, and is disposed between the cutouts 91-92b or between the cutouts 92a and 92b and the chamfered left edges of the pixel electrode 191 and secondary edges parallel to gate lines 121 or data lines 171, such that it has a planar shape of a chevron. The connection slope members 330e connect the neighboring slope members 330a-330d to each other.

Each of the slope members 330a-330d has a ridge, which is disposed approximately on center lines of the cutouts 92a, 92b, and 91, or of the chamfered edges of the pixel electrode 191 and the cutouts 92a, 92b, and parallel to the cutouts 91-92b, and inclined surfaces that have heights decreasing from the ridge to the principal edges. The third and fourth slope members 330c and 330b may include an end portion parallel to gate lines 121. The connection slope members 330e connect the first and third slope members 330a and 330c, and the second and fourth slope members 330b and 330d, respectively. The height of the ridge is preferably in a range of about 0.5-2.0 microns, and the inclination angle θ of the inclined surfaces relative to the surface of substrate 110 is preferably in a range of about 1-10 degrees. It is preferable that a set of the slope members 330a-330d occupy an area equal to or larger than half of a pixel electrode 191. The slope members 331-333b for adjacent pixel electrodes 191 may be connected to each other.

The inclined surfaces may have various shapes and be curved in the center portion as shown in FIGS. 6A and 6B. Referring to FIG. 6A, it is preferable that the inclination angle α of the slope member 330 near its bottom is equal to or less than about 10 degrees, and the inclination angle β near its center portion is equal to or less than about 5 degrees.

The inclination angles α and β are preferably equal to or lower than about 10 degrees, and the inclination angle γ is preferably equal to or greater than about 10 degrees, respectively.

In FIG. 1, the ridges of the first to fourth slope members 330a-330d are drawn as thick dotted lines and the connection slope members 330e are drawn as thin dotted lines, and the reference numerals substantially indicate the ridges and the first to fourth slope members 330a-330d.

Alignment layers 11 and 21 that may be homeotropic are coated on inner surfaces of the panels 100 and 200, and polarizers 12 and 22 are provided on outer surfaces of the panels 100 and 200 such that their polarization axes may be crossed, and one of the polarization axes may be at about 45° with respect to the slanted cutouts 92a and 92b and the ridge of the slope members 330a-330d. One of the polarizers may be omitted when the LCD is a reflective LCD.

The LCD may further include a plurality of spacers (not shown) for maintaining a cell gap between the panels 100 and 200, and at least one retardation film (not shown) for compensating the retardation of the LC layer 3. The retardation film has birefringence and imparts retardation opposite to that imparted by the LC layer 3. The retardation film may include a uniaxial or biaxial optical compensation film, and in particular a negative uniaxial compensation film.

The LCD may further include a backlight unit (not shown) for supplying light to the LC layer 3 through the polarizers 12 and 22, the retardation film, and the panels 100 and 200.

It is preferable that the LC layer 3 has negative dielectric anisotropy and it is subjected to a vertical alignment such that the LC molecules 310 in the LC layer 3 are aligned with their long axes substantially perpendicular to the surfaces of the panels 100 and 200 in the absence of an electric field.

Upon application of the common voltage to the common electrode 270 and a data voltage to the pixel electrodes 191, an electric field substantially perpendicular to the surfaces of the panels 100 and 200 is generated. The LC molecules 31 tend to change their orientations in response to the electric field such that their long axes become perpendicular to the field direction.

The cutouts 91-92b, the slope members 330a-330d, and the edges of pixel electrodes 191 control the tilt directions of the LC molecules in the LC layer 3. This will be described in detail below.

The LC molecules 31 are pre-tilted by the slope members 330a-330d in the absence of the electric field, and the pre-tilt directions of the LC molecules 310 determine the tilt directions of the LC molecules 31 upon application of the electric field, which coincide with the tilt directions determined by the cutouts 91-92b. The tilt directions of the LC molecules 31 are substantially perpendicular to the edges of the cutouts 91-92b and the edges of the pixel electrodes 191.

In addition, the slope members 330a-330d having varying thickness distort the equipotential lines of the electric field, and the distortion of the equipotential lines gives the tilting force, which also coincides with the tilt directions determined by the cutouts 91-92b and 71-72b when the dielectric constant of the slope members 331-332b is lower than that of the LC layer 3.

Accordingly, the tilt directions of the LC molecules 31 far from the cutouts 91-92b and the chamfered edges of the pixel electrodes 191 are also determined to reduce the response time of the LC molecules 31.

As shown in FIG. 1, a set of the cutouts 91-92b and the slope members 330a-330d divides a pixel electrode 191 into a plurality of sub-areas, and each sub-area has two major edges. The cutouts 91-92b of pixel electrodes 191 and the edges of pixel electrodes 191 distort the electric field to have a horizontal component that is substantially perpendicular to the edges of the cutouts 91-92b and the edges of the pixel electrodes 191. Accordingly, the LC molecules on each sub-area are tilted in a direction by the horizontal component, and the azimuthal distribution of the tilt directions is localized in four directions, thereby increasing the viewing angle of the LCD.

Furthermore, the connection slope members 330e reinforces the alignment of the LC molecules 31 disposed on the edges of pixel electrodes 191 such that the texture may be minimized thereon.

The omission of the cutout eliminates a lithography step for forming cutouts at the common electrode 270. In addition, the omission of the cutout prevents an accumulation of charge carriers at particular places, which may move to the polarizers 12 and 22 to damage them, thereby enabling omission of an ESD treatment for preventing the damage of the polarizers 12 and 22. Therefore, the omission of the cutout along with the omission of the overcoat remarkably reduces the cost for manufacturing the LCD.

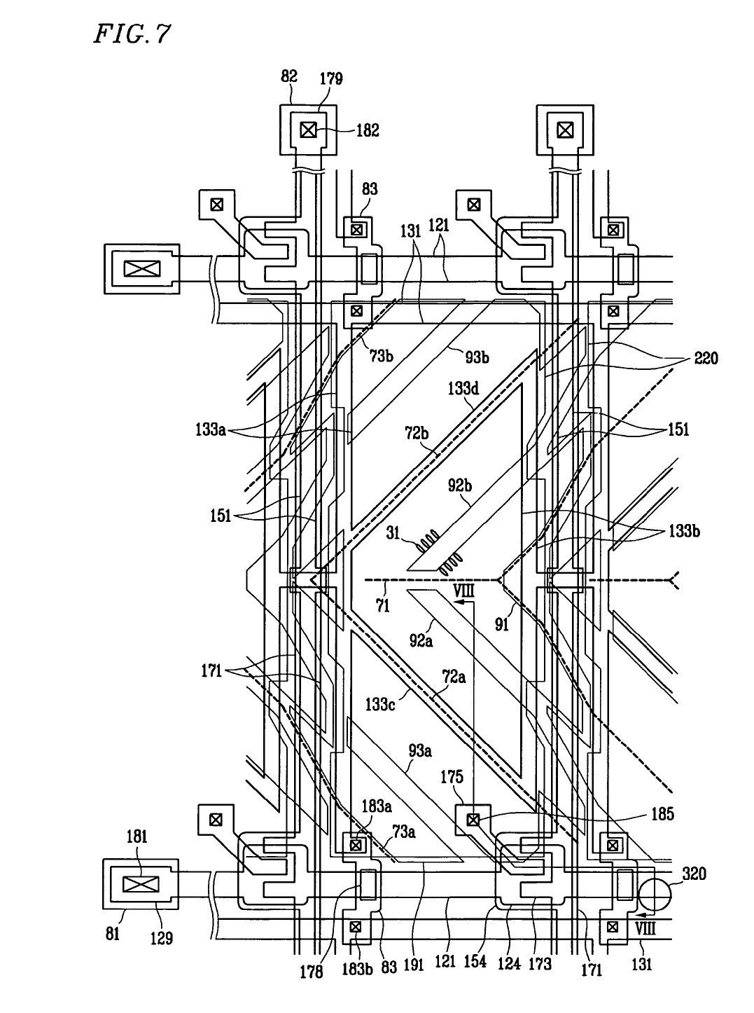

Now, a liquid crystal display according to another exemplary embodiment of the present invention will be described in detail with reference to FIGS. 7 to 9.

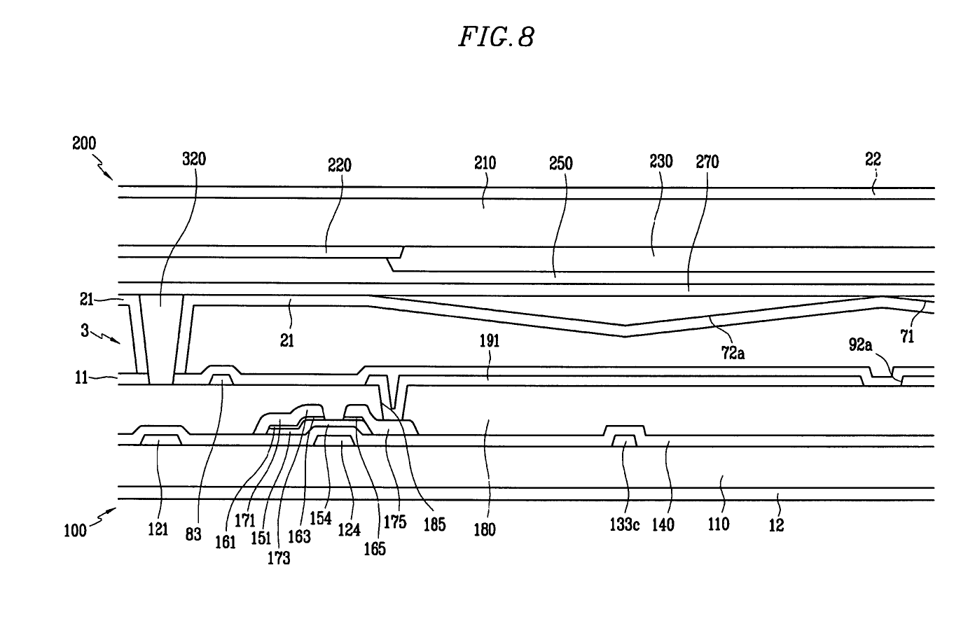

FIG. 7 is a view showing a layout of a liquid crystal display according to an exemplary embodiment of the present invention, FIG. 8 is a cross-sectional view showing the liquid crystal display taken along line VIII-VIII of FIG. 7, and FIG. 9 is a view showing a layout of a common electrode and a pixel electrode of FIG. 7.

As shown in FIGS. 7 and 8, an LCD according to this embodiment also includes a TFT array panel 100, a common electrode panel 200, and an LC layer 3 interposed between the panels 100 and 200.

The TFT array panel 100 is now described in detail with reference to the drawings.

A plurality of gate lines 121 and a plurality of storage electrode lines 131 are formed on an insulating substrate 110 made of a material such as transparent glass.

Gate lines 121 for transmitting gate signals extend mainly in the transverse direction. Gate lines 121 include a plurality of gate electrodes 124 that protrude upwardly and downwardly and end portions 129 that have wide areas for connection to other layers or external driver circuits. A gate driver circuit that generates the gate signals may be mounted on a flexible printed circuit film attached on substrate 110, or it may be directly mounted on substrate 110. Otherwise, the gate driver circuit may be integrated with substrate 110. In the case where the gate driver circuit is integrated with substrate 110, gate lines 121 are extended to be directly connected to the gate driver circuit.

Storage electrode lines 131 that are applied with predetermined voltages include stem lines that extend substantially in parallel to gate lines 121, a plurality of storage electrode sets of first, second, third, and fourth storage electrodes 133a, 133b, 133c, and 133d, and a plurality of connection portions 133e. Each of storage electrode lines 131 is disposed between adjacent two gate lines 121, and the stem line thereof is closer to the upper one of the two gate lines 121.

The first and second storage electrodes 133a and 133b extend in the longitudinal direction to face each other. First storage electrode 133a includes a fixed end connected to the stem line and a free end opposite to the fixed end, and the free end includes a protrusion. The third and fourth storage electrodes 133c and 133d extend in slanted directions from substantially about the central portion of first storage electrode 133a to the upper and lower ends of the second storage electrode 133b, respectively. The connection portions 133e are connected between adjacent storage electrode sets 133a-133d. However, various shapes and arrangements may be used for storage electrode lines 131.

Gate lines 121 and storage electrode lines 131 are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti or Ta. Gate lines 121 and storage electrode lines 131 may have a multi-layered structure including two films having different physical characteristics. One of the two films is preferably made of a low resistivity metal including an Al-containing metal, a Ag-containing metal, and a Cu-containing metal for reducing signal delay or voltage drop in gate lines 121 and storage electrode lines 131. The other film is preferably made of material such as a Mo-containing metal, Cr, Ta or Ti, which has good physical, chemical, and electrical contact characteristics with other materials such as indium tin oxide (ITO) or indium zinc oxide (IZO). Good examples of the combination of the two films are a lower Cr film and an upper Al—Nd alloy film, and a lower Al (alloy) film and an upper Mo (alloy) film. However, gate lines 121 and storage electrode lines 131 may be made of various metals and conductive materials.

In addition, the lateral sides of gate lines 121 and storage electrode lines 131 are inclined relative to a surface of the substrate, and the inclination angle thereof ranges from about 30 to 80 degrees.

A gate insulating layer 140 preferably made of silicon nitride (SiNₓ) or silicon oxide (SiOₓ) is formed on gate lines 121 and storage electrode lines 131.

A plurality of semiconductor stripes 151 preferably made of hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124. Semiconductor stripes 151 become wide near gate lines 121 and storage electrode lines 131 such that semiconductor stripes 151 cover the portions of gate lines 121 and storage electrode lines 131 with the large areas.

A plurality of ohmic contact stripes and islands 161 and 165 preferably made of silicide or n+hydrogenated a-Si heavily doped with an n-type impurity such as phosphorous are formed on semiconductor stripes 151. Each ohmic contact stripe 161 has a plurality of projections 163, and the projections 163 and the ohmic contact islands 165 are located in pairs on the projections 154 of semiconductor stripes 151.

The lateral sides of semiconductor stripes 151 and ohmic contacts 161 and 165 are inclined relative to a surface of the substrate, and the inclination angles thereof are preferably in a range of between about 30 to 80 degrees.

A plurality of data lines 171, a plurality of drain electrodes 175 separated from data lines 171, and a plurality of isolated metal pieces 178 are formed on ohmic contacts 161 and 165 and the gate insulating layer 140.

Data lines 171 for transmitting data voltages extend substantially in the longitudinal direction, and cross gate lines 121 at right angles. Data lines 171 also intersect storage electrode lines 131 and the connections 133e such that each data line 171 is disposed between the first and second storage electrodes 133a and 133b in adjacent sets of the branches 133a-133d of storage electrode lines 131. Each data line 171 includes a plurality of source electrodes 173 projecting toward the gate electrodes 124 and being curved like a crescent, and an end portion 179 having a large area for contact with another layer or an external driving circuit. A data driving circuit (not shown) for generating the data signals may be mounted on an FPC film (not shown), which may be attached to substrate 110, directly mounted on substrate 110, or integrated with substrate 110. Data lines 171 may extend to be connected to a driving circuit that may be integrated with substrate 110.

Drain electrodes 175 are separated from data lines 171 and disposed opposite the source electrodes 173 with respect to the gate electrodes 124. Each of drain electrodes 175 includes a wide end portion and a narrow end portion. The narrow end portion is partly enclosed by a source electrode 173.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The metal pieces 178 are disposed on gate lines 121 near the end portions of the first storage electrodes 133a.

Data lines 171, drain electrodes 175, and the metal pieces 178 are preferably made of a refractory metal such as Cr, Mo, Ti, Ta, or alloys thereof. However, they may also have a multilayered structure including a low-resistivity film (not shown) and a good-contact film (not shown). A good example of the combination is a lower Mo film, an intermediate Al film, and an upper Mo film, as well as the above-described combinations of a lower Cr film and an upper Al—Nd alloy film and a lower Al film and an upper Mo film. However, data lines 171 and drain electrodes 175 may be made of various metals or conductors.

Data lines 171 and drain electrodes 175 have inclined edge profiles, and the inclination angles thereof range from about 30 to 80 degrees.

Ohmic contacts 161 and 165 are interposed only between the underlying semiconductor stripes 151 and the overlying data lines 171 and overlying drain electrodes 175 thereon, and reduce the contact resistance therebetween. Semiconductor stripes 151 include a plurality of exposed portions, which are not covered with data lines 171 and drain electrodes 175, such as portions located between the source electrodes 173 and drain electrodes 175. Although semiconductor stripes 151 are narrower than data lines 171 at most places, the width of semiconductor stripes 151 becomes large near gate lines 121 and storage electrode lines 131 as described above, to smooth the profile of the surface, thereby preventing disconnection of data lines 171.

A passivation layer 180 is formed on data lines 171, drain electrodes 175, the metal pieces 178, and the exposed portions of semiconductor stripes 151. Passivation layer 180 is preferably made of an inorganic insulator such as silicon nitride or silicon oxide, a photosensitive organic material having a good flatness characteristic, or a low dielectric insulating material having dielectric constant lower than 4.0 such as a-Si:C:O and a-Si:O:F formed by plasma enhanced chemical vapor deposition (PECVD). Passivation layer 180 may include a lower film of an inorganic insulator and an upper film of an organic insulator such that it takes the excellent insulating characteristics of the organic insulator while preventing the exposed portions of semiconductor stripes 151 from being damaged with the organic insulator.

Passivation layer 180 has a plurality of contact holes 182 and 185 exposing the end portions 179 of data lines 171 and the end portions of drain electrodes 175, respectively. Passivation layer 180 and the gate insulating layer 140 have a plurality of contact holes 181 exposing the end portions 129 of the gate lines 171, a plurality of contact holes 183a exposing portions of storage electrode lines 131 near the fixed end portions of the first storage electrodes 133a, and a plurality of contact holes 183a exposing the projections of the free end portions of the first storage electrodes 133a.

A plurality of pixel electrodes 191, a plurality of contact assistants 81 and 82, and a plurality of overpasses 83, which are preferably made of a transparent conductor such as ITO or IZO or a reflective conductor such as Ag or Al, are formed on passivation layer 180.

Pixel electrodes 191 are physically and electrically connected to drain electrodes 175 through the contact holes 185 such that pixel electrodes 191 receive data voltages from drain electrodes 175. Pixel electrodes 191 that are supplied with the data voltages generate electric fields in cooperation with a common electrode 270 of the opposing common electrode panel 200 supplied with a common voltage, which determine the orientations of liquid crystal molecules 31 of a liquid crystal layer 3 disposed between the two panels 100 and 200. A pixel electrode 191 and the common electrode 270 form a capacitor referred to as a “liquid crystal capacitor,” which stores applied voltages after the TFT turns off.

A pixel electrode 191 overlaps a storage electrode line 131 including storage electrodes 133a and 133b.

Each pixel electrode 191 has lower cutouts 92a and 93a, a center cutout 91, and an upper cutout 92b and 93b, which partition the pixel electrode 191 into a plurality of partitions. The cutouts 91-93b substantially have inversion symmetry with respect to an imaginary transverse line bisecting the pixel electrode 191.

The lower and upper cutouts 92a, 92b, 93a, and 93b obliquely extend from a right edge of the pixel electrode 191 near an upper right corner approximately to a center of a left edge of the pixel electrode 191, and overlap the third and fourth storage electrodes 133c and 133d. The lower and upper cutouts 92a, 92b, 93a and 93b are disposed at lower and upper halves of the pixel electrode 191, respectively, which can be divided by the imaginary transverse line. The lower and upper cutouts 92a, 92b, 93a, and 93b form an angle of about 45 degrees to gate lines 121, and they extend substantially perpendicular to each other.

The center cutout 91 extends along the imaginary transverse line and has an inlet from the right edge of the pixel electrode 191, which has a pair of inclined edges substantially parallel to the lower cutouts 92a and 93a, and the upper cutouts 92b and 93b, respectively.

Accordingly, the lower half of the pixel electrode 191 is partitioned into four lower partitions by the lower cutouts 92a and 92b, and the upper half of the pixel electrode 191 is partitioned into four upper partitions by the upper cutouts 92b and 93b.

The number of partitions or the number of cutouts is varied depending on design factors such as the size of pixels, the ratio of the transverse edges and the longitudinal edges of pixel electrodes 191, the type and characteristics of the liquid crystal layer 3, and so on. Furthermore, the number of cutouts of the neighboring pixel electrodes 191 may be varied to arrange the same domains in the right and left sides with respect to the gaps of the neighboring pixel electrodes 191 in the panels. When the cutouts of the lower panel 100 and the cutouts of the upper panel 200 are alternatively disposed, the alignments of domains may be uniform.

Referring to FIG. 9, each pixel electrode 191 has a pair of first primary edges 193 and 194 facing each other and a pair of second primary edges 195 and 196 connected to the first primary edges 193 and 194. The first primary edges 193 and 194 are substantially parallel to the gate line 121, and the second primary edges 195 and 196 have inner and outer envelopes 951, 961, 952, and 962. The inner and outer envelopes 951, 961, 952, and 962 of the second primary edges 195 and 196 are substantially perpendicular to the first primary edges 193 and 194. Left corners of the pixel electrode 191 are constructed with chamfered slanted edges 193c and 194c, and the chamfered slanted edges 193c and 194c form a slanted angle of about 45° with respect to the gate line 121.

The second primary edges 195 and 196 of the pixel electrode 191 have a plurality of sawteeth 910 and 920 that protrude outwardly from a plurality of longitudinal lines 915 and 916 on the inner envelopes 951 and 961. The sawteeth 910 and 920 are symmetrical with respect to the transverse central line of the pixel electrode 191.

Each of the sawteeth 910 (920) has a first slanted edge 911 (921), a second slanted edge 912 (922), and a top edge 913 (923) that is disposed on the outer envelop 952 (962) to connect the first and second slanted edges. The first slanted edge 911 (912) forms an obtuse angle of about 135° or more with respect to the longitudinal line 915 (925), and the second edge 912 (922) forms an angle of about 45° with respect to the longitudinal line 915 (925). The extension lines of the first and second slanted edges 911 (912) and 912 (922) intersect each other with an acute angle of about 45° or less. In addition, the second edges 912 and 922 are substantially parallel to the lower and upper cutouts 92a and 92b and are located on the extension lines of the cutouts 92a and 92b, respectively. The first edges 911 and 921 form an angle of about 45° or less or about 135° or more with respect to the lower and upper cutouts 92a and 92b.

The upper portions of the sawteeth 910 and 920, that is, portions near the top edges 913 and 923 thereof, overlap the data line 171. The sawteeth 920 of the right edge 196 of the pixel electrode 191 that are located at the left of the data line 171 are engaged with the sawteeth 910 of the pixel electrode 191 that are located at the left of the data line 171. In addition, the facing edges of the engaged sawteeth 910 and 920 are parallel to each other.

The number of sawteeth 910 and 920 are in close relation to the number of partitions of the pixel electrode 191 divided by the cutouts 91, 92a, and 92b or the number of cutouts 91, 92a, and 92b. The number of partitions of the pixel electrode 191 and the number of sawteeth 910 and 920 may vary according to design factors such as a size of the pixel electrode 191, the ratio of lengths of the transverse and longitudinal sides of the pixel electrode 191, and the types or characteristics of the liquid crystal layer 3.

The overpasses 83 cross over gate lines 121, and are connected to the exposed projection of the fixed end portions of the first storage electrodes 133a and the exposed portions of storage electrode lines 131 through the contact holes 183b and 183a, respectively, which are disposed opposite each other with respect to gate lines 121. The overpasses 83 overlap the metal pieces 178, and they may be electrically connected to the metal pieces 178. Storage electrode lines 131 including the storage electrodes 133a-133d along with the overpasses 83 and the metal pieces 178 are used for repairing defects in gate lines 121, data lines 171, or the TFTs.

The contact assistants 81 and 82 are connected to the end portions the end portions 129 of gate lines 121 and the end portions 179 of data lines 171 through the contact holes 181 and 182, respectively. The contact assistants 81 and 82 protect the end portions 129 and 179 and complement the adhesion of the end portions 129 and 179 and external devices.

A description of the common electrode panel 200 follows with reference to FIGS. 7-9.

A light blocking member 220 called a black matrix for preventing light leakage is formed on an insulating substrate 210 made of a material such as transparent glass. The light blocking member 220 may include a plurality of opening portions 225 that face pixel electrodes 191 and have a shape of a substantial rectangle. A width of the light blocking member 220 corresponding to the date lines 171 is substantially the same as that of data lines 171. However, the widths may be defined by taking into consideration alignment error of the panels 100 and 200. The light blocking member 220 may include enlarged portions that block spaces between the engaged sawteeth 910 and 920 that protrude outwardly from data lines 171. The light blocking member 220 may include portions corresponding to the thin film transistors.

A plurality of color filters 230 are formed on the substrate 210, and they are disposed substantially in the areas enclosed by the light blocking member 220. The color filters 230 may extend substantially along the longitudinal direction along the pixel electrodes 191. The color filters 230 may represent one of the primary colors such as red, green, and blue, and the edges of the color filters 30 may overlap each other.

An overcoat 250 for preventing the color filters 230 from being exposed and for providing a flat surface is formed on the color filters 230 and the light blocking member 220. The overcoat 250 may be omitted.

A common electrode 270 preferably made of a transparent conductive material such as ITO and IZO is formed on the overcoat 250.

A plurality of sets of slope members 71, 72a, 72a, 73a, 73b, and 75 preferably made of an insulator are formed on the common electrodes 270. The dielectric constant of the slope members 71-73b and 75 is preferably equal to or lower than that of the LC layer 3.

Each set of the slope members 71-73b and 75 includes slanted slope members 72a-73b and a central slope member 71 opposing a pixel electrode 191, and a connection slope member 75. Each of the slope members 71-73b has principal edges parallel to edges of the cutouts 91-92b and the chamfered left edges of the pixel electrode 191, and is disposed between the cutouts 91-92b or between the cutouts 92a and 92b and the chamfered left edges of the pixel electrode 191 and secondary edges parallel to gate lines 121 or data lines 171, such that it has a planar shape of a parallelogram or chevron. The connection slope members 75 face and are lined up with the gaps of pixel electrodes 191, and connect the neighboring slanted slope members 71-73b to each other.

Also, each of the slope members 71-73b and 75 has a ridge and inclined surfaces, and they are drawn with dotted lines in the drawings, as in FIGS. 1 to 5.

The ridge of the central slope member 71 includes a transverse ridge and a slanted ridge. The transverse ridge extends substantially from along the transverse central line of the pixel electrode 191, and the slanted ridge extends substantially from the end of the transverse portion to the right edges of pixel electrodes 191 and overlaps the oblique side of the cutouts 91 of pixel electrodes 191.

Each of the ridges of the lower and upper slope members 72a, 72b, 73a, and 73b are disposed approximately between the cutouts 91-93b of pixel electrodes 191, the chamfered edges of the pixel electrode 191 and the cutouts 93a and 93b, and they are parallel to the cutouts 91-93b, and overlap the chamfered edges of the pixel electrode 191. The inclined surfaces have decreasing heights from the ridge to the principal edges. The height of the ridges is preferably in a range of about 0.5-2.0 microns, and the inclination angle θ of the inclined surfaces relative to the surface of substrate 110 is preferably in a range of about 1 to 10 degrees. The number of slope members 71-73b and 75 may vary according to design factors.

Spacers 320 made of an insulating material are disposed on the common electrode panel 200 to maintain a constant interval between the panels 100 and 200.

Alignment layers 11 and 21 that may be homeotropic are coated on inner surfaces of the panels 100 and 200, and polarizers 12 and 22 are provided on outer surfaces of the panels 100 and 200 such that their polarization axes may be crossed and one of the polarization axes may be about 45° with respect to the slanted cutouts 92a-93b and the ridge of the slope members 71-73b. One of the polarizers may be omitted when the LCD is a reflective LCD.

The LCD may further include at least one retardation film (not shown) for compensating the retardation of the LC layer 3. The retardation film has birefringence, and imparts retardation opposite to that given by the LC layer 3. The retardation film may include a uniaxial or biaxial optical compensation film, and in particular a negative uniaxial compensation film.

The LCD may further include a backlight unit (not shown) for supplying light to the LC layer 3 through the polarizers 12 and 22, the retardation film, and the panels 100 and 200.

It is preferable that the LC layer 3 has negative dielectric anisotropy, and that it is subjected to a vertical alignment such that the LC molecules 310 in the LC layer 3 are aligned with their long axes substantially perpendicular to the surfaces of the panels 100 and 200 in the absence of an electric field. Consequently, incident light cannot pass through the perpendicular polarizers 12 and 22 and is blocked.

Upon application of the common voltage to the common electrode 270 and a data voltage to the pixel electrodes 191, an electric field substantially perpendicular to the surfaces of the panels 100 and 200 is generated. The LC molecules 31 tend to change their orientations in response to the electric field such that their long axes become perpendicular to the field direction.

Referring to FIG. 9, one cutout set 91-93b and slope members 71-73b and 75 divide the pixel electrode 191 into a plurality of sub-areas. Each of the sub-areas has two primary edges that are slanted with respect to the first primary edges 193 and 194 of the pixel electrode 191 and secondary edges that are some portions of the edges 193 to 196 of the pixel electrode 191. One of the primary edges of each sub-area is constructed by combining one edge of the cutouts 91-93b of the pixel electrode 191 with the secondary edges 912 and 922 of the sawteeth 910 and 920 or is constructed with the chamfered slanted edges 193c and 194c. The other of the primary edges is constructed with a single edge of the slanted portion of the cutouts 71-73b of the common electrode 270 or is constructed by combining the slanted portions of the cutouts 71-73b with the slanted edges 912 and 922 of the sawteeth 910 and 920. Therefore, the lengths of the primary edges of the sub-areas are different from each other, and the adjacent primary edges of the adjacent sub-areas are disposed to deviate from each other. One of the secondary edges of the sub-areas is the first slanted edge 911 (921) of each of the sawteeth 910 (920) of the pixel electrode 191, and forms an angle of about 135° or more with respect to the primary edges. The primary edges form an angle of about 45° with respect to the polarization axes of the polarizers 12 and 22 to maximize light efficiency.

The primary edges are longer than the secondary edges, and at least one of the secondary edges forms an angle of about 135° or more with respect to the primary edges. Therefore, in the primary electric field on the sub-areas, the horizontal component thereof that is perpendicular to the primary edges is much larger than the horizontal component thereof that is parallel to the primary edges. As a result, most of the liquid crystal molecules 31 on the sub-areas are tilted in directions perpendicular to the primary edges.

Since most of the liquid crystal molecules 31 on the sub-areas are tilted in directions perpendicular to the primary edges, the tilted directions may roughly include four directions. Moreover, since the liquid crystal molecules 31 can be adjusted to have various tilt angles, it is possible to increase the reference viewing angle of the liquid crystal display.

On the other hand, secondary electric fields (lateral fields) E1 and E2 are additionally generated from the difference between voltages of pixel electrodes 191. Directions of the secondary electric fields E1 and E2 are mainly perpendicular to one of the secondary edges of the sub-areas, that is, the first slanted edge 911 (921) of the sawteeth 910 (920). Therefore, the directions of the secondary electric fields E1 and E2 form an angle of about 15° or less with respect to the direction of the horizontal component of the primary electric field. As a result, the secondary electric fields E1 and E2 between pixel electrodes 191 have a tendency to fix the tilted directions of the liquid crystal molecules 31.

By providing the sawteeth 910 and 920 having the slanted edges 911 and 922 with an angle of about 135° or more with respect to the cutouts 91-92b and the slope members 71-73b and 75 to the transverse sides of the pixel electrode 191, the direction of the horizontal component of the primary electric field and the secondary electric field in the vicinities of the longitudinal sides 195 and 196 of the pixel electrode 191 are allowed to be substantially equal to the direction of the horizontal component of the primary electric field in the vicinities of the sub-areas. Also, by shortening the distance between pixel electrodes 191, the strength of the secondary electric field is allowed to increase. As a result, the tilted direction of the liquid crystal molecules 31 located in the vicinities of the sawteeth 910 and 920 of the pixel electrode 191 are allowed to be substantially equal to the tilted direction of the liquid crystal molecules 31 located at the centers of the sub-areas, so that the vicinities of the sawteeth 910 and 920 can be used as an effective display region.

The addition of the sawteeth 910 and 920, the exemplary embodiments of the present invention provide increased transmittance of the liquid crystal display. In addition, since with the exemplary embodiments of the present invention it is not necessary to provide the portions overlapping the longitudinal sides of the pixel electrode 191 to the cutout of the common electrode 270, the aperture ratio of the liquid crystal display can thereby also be increased.

The cutouts 91-92b of pixel electrodes 191 and the edges of pixel electrodes 191 distort the electric field to have a horizontal component that is substantially perpendicular to the edges of the cutouts 91-92b and the edges of the pixel electrodes 191.

In addition, the slope members 71-73b and 75 having varying thicknesses distort the equipotential lines of the electric field, and the distortion of the equipotential lines gives the tilting force, which also coincides with the tilt directions determined by the cutouts 91-92b when the dielectric constant of the slope members 331-332b is lower than that of the LC layer 3. The response of the liquid crystal display can thereby also be increased.

Furthermore, the connection slope members 75 reinforce the alignment of the LC molecules 31 disposed on the edges of pixel electrodes 191 such that the texture may be minimized thereon.

The omission of the cutout removes a lithography step for forming cutouts at the common electrode 270. In addition, the omission of the cutout prevents the accumulation of charge carriers at particular places, which may move to the polarizers 12 and 22 to damage them, thereby enabling omission of an ESD treatment for preventing damage of the polarizers 12 and 22. Therefore, the omission of the cutout along with the omission of the overcoat remarkably reduces the cost for manufacturing the LCD.

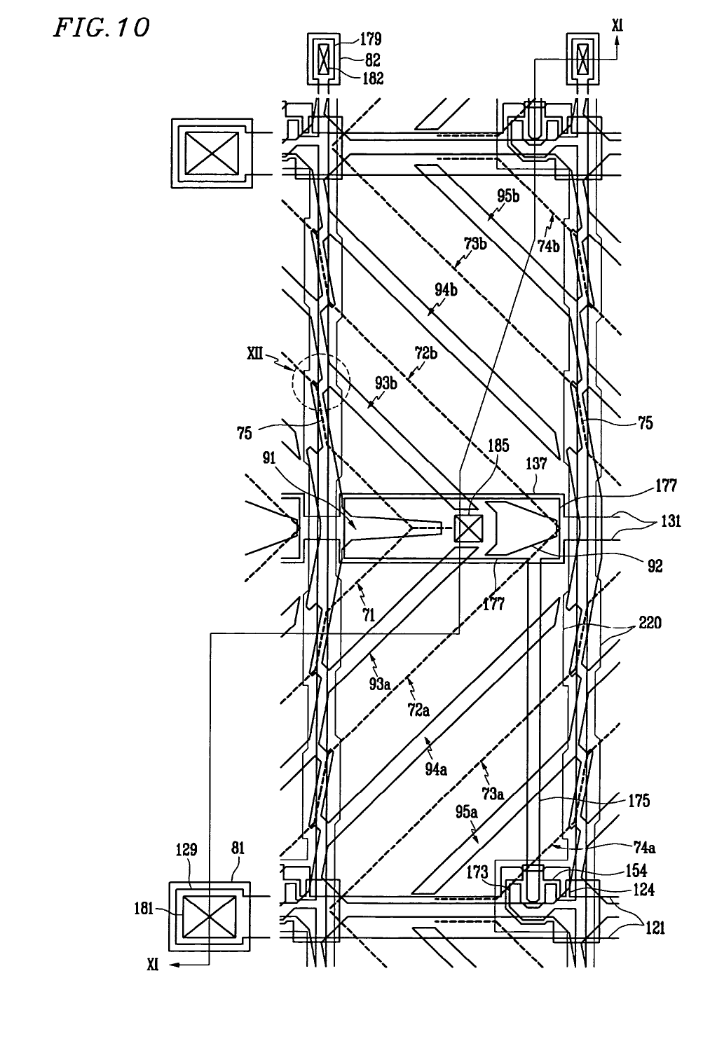

Now, a liquid crystal display according to another exemplary embodiment of the present invention will be described in detail with reference to FIGS. 10 to 12.

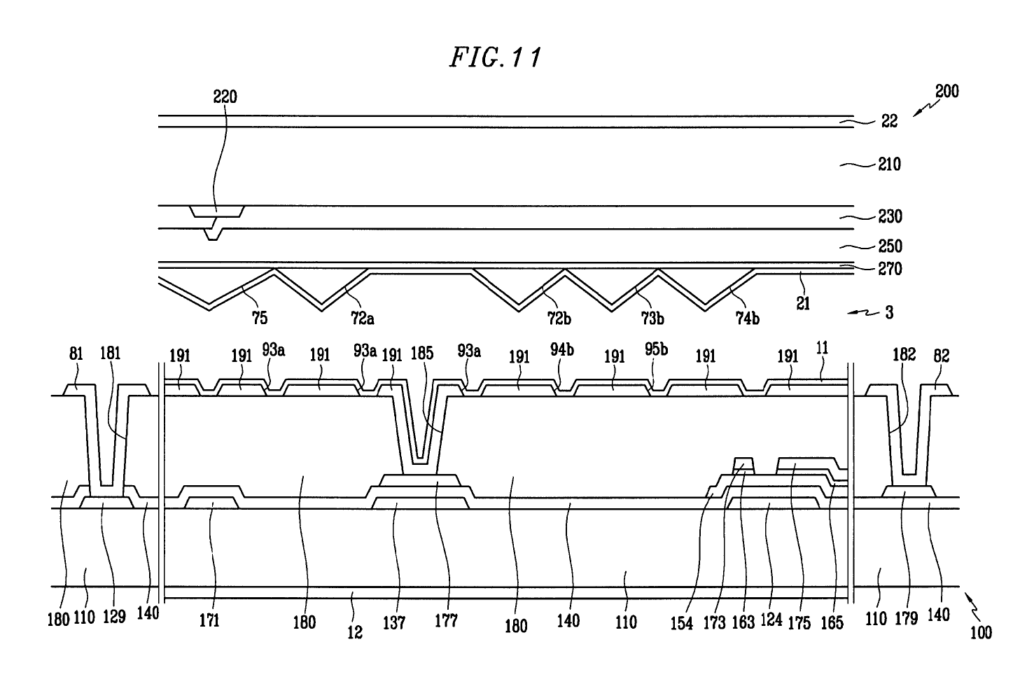

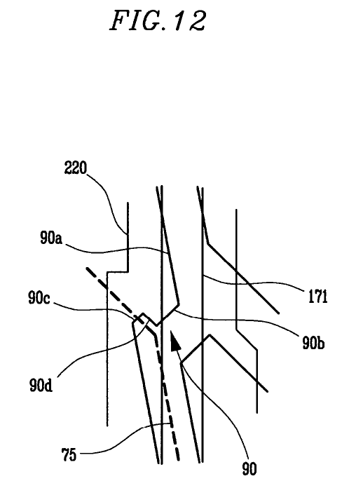

FIG. 10 is a view showing a layout of a liquid crystal display according to an exemplary embodiment of the present invention, FIG. 11 is a cross-sectional view showing the liquid crystal display taken along line XI-XI of FIG. 10, and FIG. 12 is an enlarged view showing a portion of the liquid crystal display of FIG. 10.

As shown in FIGS. 10 to 12, an LCD according to this embodiment also includes a TFT array panel 100, a common electrode panel 200, and an LC layer 3 interposed between the panels 100 and 200.

The TFT array panel 100 is now described in detail with reference to the drawings.

A plurality of gate lines 121 and a plurality of storage electrode lines 131 are formed on an insulating substrate 110 made of a material such as transparent glass.

Gate lines 121 for transmitting gate signals mainly extend in the transverse direction. Gate lines 121 include a plurality of gate electrodes 124 that protrude upwardly and end portions 129 that have wide areas for connection to other layers or external driver circuits. A gate driver circuit that generates the gate signals may be mounted on a flexible printed circuit film attached on substrate 110, or it may be directly mounted on substrate 110. Otherwise, the gate driver circuit may be integrated with substrate 110. In the case where the gate driver circuit is integrated with substrate 110, gate lines 121 are extended to be directly connected to the gate driver circuit.

Storage electrode lines 131 that are applied with predetermined voltages extend substantially in parallel to gate lines 121, and include a plurality of storage electrode 137 that protrude upwardly and downwardly. Each of storage electrode lines 131 is disposed between two adjacent gate lines 121. However, various shapes and arrangements may be used for storage electrode lines 131.

Gate lines 121 and storage electrode lines 131 are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti or Ta. Gate lines 121 and storage electrode lines 131 may have a multi-layered structure including two films having different physical characteristics. One of the two films is preferably made of a low resistivity metal including an Al-containing metal, a Ag-containing metal, and a Cu-containing metal for reducing signal delay or voltage drop in gate lines 121 and storage electrode lines 131. The other film is preferably made of a material such as a Mo-containing metal, Cr, Ta or Ti, which has good physical, chemical, and electrical contact characteristics with other materials such as indium tin oxide (ITO) or indium zinc oxide (IZO). Good examples of the combination of the two films are a lower Cr film and an upper Al—Nd alloy film, and a lower Al (alloy) film and an upper Mo (alloy) film. However, gate lines 121 and storage electrode lines 131 may be made of various metals and conductive materials.

In addition, the lateral sides of gate lines 121 and storage electrode lines 131 are inclined relative to a surface of the substrate, and the inclination angle thereof ranges from about 30 to 80 degrees.

A gate insulating layer 140 preferably made of silicon nitride (SiNₓ) or silicon oxide (SiOₓ) is formed on gate lines 121 and storage electrode lines 131.

A plurality of semiconductors 154 preferably made of hydrogenated amorphous silicon (abbreviated to “a-Si”) or polysilicon are formed on the gate insulating layer 140. Each semiconductor is disposed on the gate electrodes 124. The semiconductors 154 become wide near gate lines 121 such that the semiconductors 154 cover the portions of gate lines 121 with the large areas.

A plurality of ohmic contacts 163 and 165 preferably made of silicide or n+hydrogenated a-Si heavily doped with an n-type impurity such as phosphorous are formed on the semiconductors 154. Each pair of ohmic contacts 163 and 165 are located in pairs on the semiconductors 154.

The lateral sides of the semiconductors 154 and the ohmic contacts 163 and 165 are inclined relative to a surface of the substrate, and the inclination angles thereof are preferably in a range of between about 30 to 80 degrees.

A plurality of data lines 171 and a plurality of drain electrodes 175 separated from data lines 171 are formed on the ohmic contacts 163 and 165 and the gate insulating layer 140.

Data lines 171 for transmitting data voltages extend substantially in the longitudinal direction, and cross gate lines 121 and storage electrode lines 131. Each data line 171 includes a plurality of source electrodes 173 projecting toward the gate electrodes 124 and being curved like a crescent, and an end portion 179 having a large area for contact with another layer or an external driving circuit. A data driving circuit (not shown) for generating the data signals may be mounted on an FPC film (not shown), which may be attached to substrate 110, directly mounted on substrate 110, or integrated with substrate 110. Data lines 171 may extend to be connected to a driving circuit that may be integrated with substrate 110.

Drain electrodes 175 are separated from data lines 171 and disposed opposite the source electrodes 173 with respect to the gate electrodes 124. Each of drain electrodes 175 includes a wide end portion 177 and a narrow end portion. The narrow end portion is partly enclosed by a source electrode 173 with a “U” shape.

A gate electrode 124, a source electrode 173, and a drain electrode 175 along with a semiconductor 154 form a TFT having a channel formed in the semiconductor 154 disposed between the source electrode 173 and the drain electrode 175.

Data lines 171 and drain electrodes 175 are preferably made of a refractory metal such as Cr, Mo, Ti, Ta, or alloys thereof. However, they may also have a multilayered structure including a low-resistivity film (not shown) and a good-contact film (not shown). A good example of the combination is a lower Mo film, an intermediate Al film, and an upper Mo film as well as the above-described combinations of a lower Cr film and an upper Al—Nd alloy film and a lower Al film and an upper Mo film. However, data lines 171 and drain electrodes 175 may be made of various metals or conductors.

Data lines 171 and drain electrodes 175 have inclined edge profiles, and the inclination angles thereof range from about 30 to 80 degrees.

Ohmic contacts 161 and 165 are interposed only between the underlying semiconductors 154 and the overlying data lines 171 and overlying drain electrodes 175 thereon, and reduce the contact resistance therebetween.

A passivation layer 180 is formed on data lines 171, drain electrodes 175, and the exposed portions of the semiconductors 154. Passivation layer 180 is preferably made of an inorganic insulator such as silicon nitride or silicon oxide, a photosensitive organic material having a good flatness characteristic, or a low dielectric insulating material having a dielectric constant lower than 4.0 formed by plasma enhanced chemical vapor deposition (PECVD). Passivation layer 180 may include a lower film of an inorganic insulator and an upper film of an organic insulator such that it takes the excellent insulating characteristics of the organic insulator while preventing the exposed portions of the semiconductor 154 from being damaged with the organic insulator.

Passivation layer 180 has a plurality of contact holes 182 and 185 exposing the end portions 179 of data lines 171 and the end portions of drain electrodes 175, respectively. Passivation layer 180 and the gate insulating layer 140 have a plurality of contact holes 181 exposing the end portions 129 of the gate lines 171.

A plurality of pixel electrodes 191 and a plurality of contact assistants 81 and 82, which are preferably made of a transparent conductor such as ITO or IZO or a reflective conductor such as Ag or Al, are formed on passivation layer 180.

Pixel electrodes 191 are physically and electrically connected to drain electrodes 175 through the contact holes 185 such that pixel electrodes 191 receive data voltages from drain electrodes 175. Pixel electrodes 191 overlap the storage electrodes 137 as well as storage electrode lines 131.

Each pixel electrode 191 has a pair of first primary edges 193 and 194 facing each other, and second primary edges that are connected to the first primary edges 193 and 194 and include a plurality of sawteeth 90 and lower edges 90c connecting the sawteeth 90. Each of the sawteeth 90 includes first and second slanted edges 90a and 90d that are slanted with respect to the first primary edges 193 and 194 and an upper edge 90b. The first primary edges 193 and 194 are parallel to gate lines 121. The first primary edges 193 and 194 and the second primary edges constitute an approximate rectangle. The pixel electrode 191 has four chamfered corners that form an angle of about 45° with respect to gate lines 121.

The first slanted edge 90a partially overlaps the data line 171. The first slanted edges 90a of two adjacent pixel electrodes 191 are disposed to face each other in parallel to each other.

First and second central cutouts 91 and 92, lower slanted cutouts 93a, 94a, and 95a, and upper slanted cutouts 93b, 94b, and 95b are formed on the pixel electrode 191. Therefore, the pixel electrode 191 is divided into a plurality of sub-areas by the cutouts 91 to 95b. The cutouts 91 to 95b have inversion symmetry with respect to the storage electrode line 131. The lower slanted cutouts 93a, 94a, and 95a and the upper slanted cutouts 93b, 94b, and 95b extend substantially in the slanted directions from the right side to the left, upper, or lower side of the pixel electrode 191. The lower slanted cutouts 93a, 94a, and 95a and the upper slanted cutouts 93b, 94b, and 95b are disposed in lower and upper half regions of the pixel electrode 191 with respect to the storage electrode line 131. The lower slanted cutouts 93a, 94a, and 95a and the upper slanted cutouts 93b, 94b, and 95b extend perpendicularly to each other with slanted angles of about 45° with respect to the gate line 121. Each of the lower slanted cutouts 93a, 94a, and 95a and the upper slanted cutouts 93b, 94b, and 95b has an inlet at the right or left side of the pixel electrode 191. The inlets may be connected to the concave portions of the sawteeth 90.

The first slanted edges 90a of the sawteeth 90 of the second primary edges form an obtuse angle with respect to the slanted cutouts 93a to 95a and 93b to 95b, and the second slanted edges 90d thereof are substantially parallel to the slanted cutouts 93a to 95a and 93b to 95b.

The first central cutout 91 extends along the storage electrode line 131 and has an inlet toward the left side of the pixel electrode 191. The second central cutout 92 has a shape of a polygon of which upper and lower corners protrude toward the left sides of the pixel electrode 191.

As a result, the lower half region of the pixel electrode 191 is divided into four partitions by the lower slanted cutouts 93a, 94a, and 95a, and the upper half region thereof is divided into four partitions by the upper slanted cutouts 93b, 94b, and 95b.

The number of partitions and the number of cutouts may vary according to design factors such as a size of the pixel electrode 191, a ratio of lengths of the transverse and longitudinal sides of the pixel electrode 191, and types or characteristics of the liquid crystal layer 3.

The contact assistants 81 and 82 are connected to the end portions 129 of gate lines 121 and the end portions 179 of data lines 171 through the contact holes 181 and 182, respectively. The contact assistants 81 and 82 protect the end portions 129 and 179 and complement the adhesion of the end portions 129 and 179 and external devices.

A description of the common electrode panel 200 follows with reference to FIGS. 10 to 12.

A light blocking member 220 called a black matrix for preventing light leakage is formed on an insulating substrate 210 made of a material such as transparent glass. The light blocking member 220 includes a plurality of line portions corresponding to the date lines 171 and a plurality of surface portions corresponding to the thin film transistors, and defines a plurality of openings (not shown) that face pixel electrodes 191. The light blocking member 220 may include enlarged portions that block spaces between the pixel electrodes.

A plurality of color filters 230 are formed on the substrate 210, and they are disposed substantially in the areas enclosed by the light blocking member 220. The color filters 230 may extend substantially along the longitudinal direction along the pixel electrodes 191. The color filters 230 may represent one of the primary colors such as red, green, and blue, and the edges of the color filters 30 may overlap each other.

An overcoat 250 for preventing the color filters 230 from being exposed and for providing a flat surface is formed on the color filters 230 and the light blocking member 220. The overcoat 250 may be omitted.

A common electrode 270 preferably made of a transparent conductive material such as ITO and IZO is formed on the overcoat 250.

A plurality of sets of slope members 71, 72a, 72a, 73a, 73b, 74a, 74b, and 75 preferably made of an insulator are formed on the common electrodes 270. The dielectric constant of the slope members 71-75 is preferably equal to or lower than that of the LC layer 3. One cutout set 71-75 faces one pixel electrode 191 and includes a central cutout 71, first to third lower slanted cutouts 72a, 73a, and 74a, first to third upper slanted cutouts 72b, 73b, and 74b, and a connection portion 75.

Each of the slope members 71-75 has principal edges parallel to edges of the cutouts 91-95b and the chamfered left edges of the pixel electrode 191, and is disposed between the cutouts 91-95b or between the cutouts 95a and 95b and the chamfered left edges of the pixel electrode 191 and secondary edges parallel to gate lines 121 or data lines 171 such that it has a planar shape of a parallelogram or chevron. The connection slope members 75 face and are lined up the gaps of pixel electrodes 191 and connect the neighboring slanted slope members 71-74b to each other.

Also, each of the slope members 71-73b and 75 has a ridge and inclined surfaces, and is drawn with dotted lines in the drawings, as in FIGS. 1 to 5. The thick dotted lines indicate the ridges of the central cutout 71, first to third lower slanted cutouts 72a, 73a, and 74a, and first to third upper slanted cutouts 72b, 73b, and 74b, and the thin dotted lines indicate the ridges of the connection portions 75. Each ridge of the cutouts 71, 72a, 72b, 73a, 73b, 74a, and 74b includes at least one slanted portion that extends substantially in parallel to the lower cutouts 93a, 94a, and 95a or upper cutouts 93b, 94b, and 95b of the pixel electrode 191.

The first lower and upper slanted cutouts 72a and 72b extend substantially from the right side of the traverse central line of the pixel electrode 191 to the left side of the pixel electrode 191. The second lower and upper slanted cutouts 73a and 73b extend substantially from the right side to the upper and lower left corners of the pixel electrode 191, respectively. The third lower and upper slanted cutouts 74a and 74b extend substantially from the right side to the lower and upper sides of the pixel electrode 191, respectively. The third lower and upper slanted cutouts 74a and 74b include terminated transverse portions that extend from the ends of the third lower and upper slanted cutouts 74a and 74b to overlap the lower and upper sides of the pixel electrode 191. The terminated transverse portions form an obtuse angle with respect to the slanted cutouts 74a and 74b.

The central cutout 71 includes a central transverse portion and a pair of slanted portions. The central transverse portion extends substantially along the storage electrode line 131 and overlaps the transverse central of the pixel electrode 191. A pair of the slanted portions extend substantially in parallel to the lower and upper cutouts 72a, 72b, 73a, 73b, 74a, and 74b from the end of the central transverse portion to the left side of the pixel electrode 191.

One end of one slanted portion of the central cutout 71 and one end of the second lower cutout 73a of the adjacent pixel electrode 191 are connected with one of the connection portions 75. Additionally, one end of the other slanted portion of the central cutout 71 and one end of the second upper cutout 73b of the adjacent pixel electrode are connected with one of the connection portions 75. Also, one end of the first lower slanted cutout 72a and one end of the third lower slanted cutout 74a of the adjacent pixel electrode are connected with one of the connection portions 75. Moreover, one end of the first upper slanted cutout 72b and one end of the third upper slanted cutout 74b of the adjacent pixel electrode are connected with one of the connection portions 75. The connection portions 75 are parallel to the first slanted edges 90a of the pixel electrode 191 and are located at portions corresponding to the data line 171.

The inclined surfaces have decreasing heights from the ridge to the principal edges. The height of the ridge is preferably in a range of about 0.5-2.0 microns, and the inclination angle θ of the inclined surfaces relative to the surface of substrate 110 is preferably in a range of about 1 to 10 degrees.

It is preferable that a set of the slope members 71-74b occupy an area equal to or larger than half of a pixel electrode 191. The slope members 71-74b for adjacent pixel electrodes 191 may be connected to each other.

Thus, by providing the sawteeth to the side of the pixel electrode 191 adjacent to the data line 171, as described above in the exemplary embodiment shown in FIGS. 7 to 9, the secondary electric field generated between the adjacent pixel electrodes 191 can control the alignment of the liquid crystal molecules 31 in the sub-areas. In addition, by providing the connection portions 75 at the positions corresponding to the regions where the first slanted edges 90a of the adjacent two pixel electrodes 191 face each other, the alignment of the liquid crystal molecules 31 in the sub-areas can be controlled as well.

The number and directions of the cutout 71 to 75 may vary according to design factors.

Alignment layers 11 and 21 that may be homeotropic are coated on inner surfaces of the panels 100 and 200, and polarizers 12 and 22 are provided on outer surfaces of the panels 100 and 200 such that their polarization axes may cross, and one of the polarization axes may be parallel to the gate line 121. One of the polarizers may be omitted when the LCD is a reflective LCD.

The LCD may further include a backlight unit (not shown) for supplying light to the LC layer 3 through the polarizers 12 and 22, the retardation film, and the panels 100 and 200.

It is preferable that the LC layer 3 has negative dielectric anisotropy and is subjected to a vertical alignment such that the LC molecules 310 in the LC layer 3 are aligned with their long axes substantially perpendicular to the surfaces of the panels 100 and 200 in the absence of an electric field. Consequently, incident light cannot pass through the perpendicular polarizers 12 and 22 and is blocked.

The above-described exemplary embodiments may be applied to the later-described exemplary embodiments.

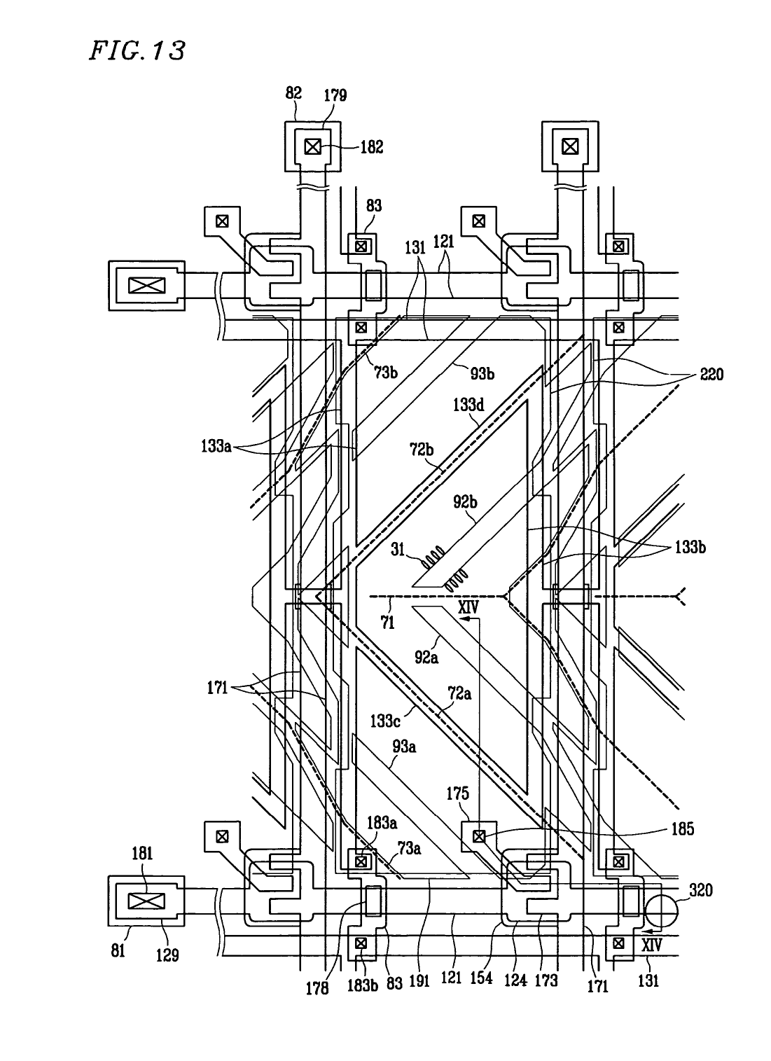

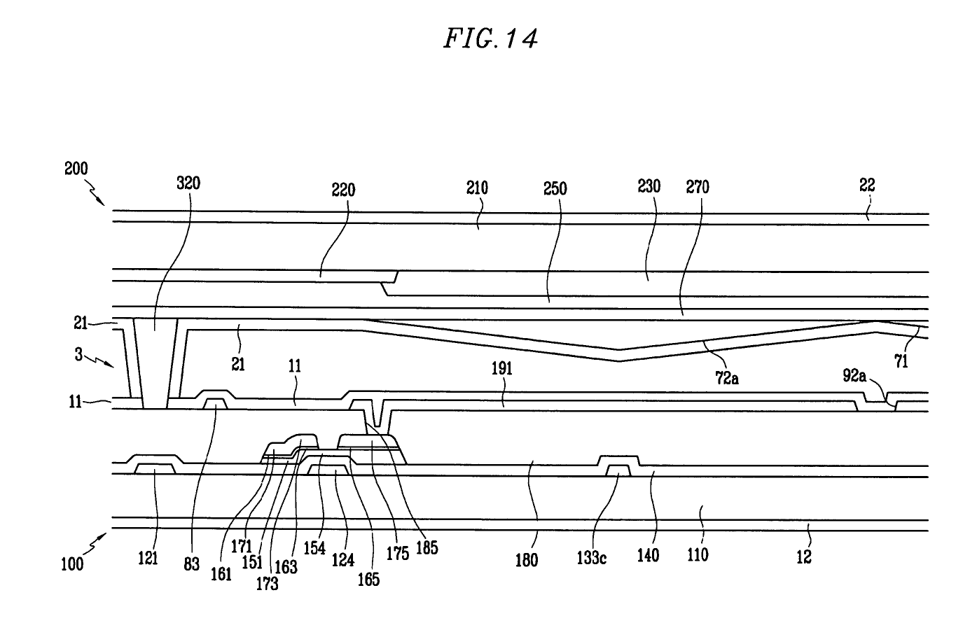

Now, a liquid crystal display according to another exemplary embodiment of the present invention will be described in detail with reference to FIGS. 13 and 14.

FIG. 13 is a view showing a layout of a liquid crystal display according to another exemplary embodiment of the present invention, and FIG. 14 is a cross-sectional view showing the liquid crystal display taken along line XIV-XIV of FIG. 13.

As shown in FIGS. 13 and 14, the liquid crystal display includes a thin film transistor panel 100 and a common electrode panel 200 that face each other, a liquid crystal layer 3 interposed between the panels 100 and 200, and a pair of polarizers 12 and 22 disposed on outer surfaces of the panels 100 and 200.

The layered structures of the panels 100 and 200 according to the present exemplary embodiment are substantially the same as the layered structures of FIGS. 7 and 8.

In the thin film transistor panel 100, a plurality of gate lines 121 and a plurality of storage electrode lines 131 are disposed on a substrate 110. Gate lines 121 include a plurality of gate electrodes 124 and end portions 129. Storage electrode lines 131 include a plurality of storage electrodes 133a to 133d and a plurality of connection portions 133e. A gate insulating layer 140, a plurality of semiconductor stripes 151 including protrusions 154, a plurality of ohmic contact stripes 161 including protrusions 163, and a plurality of ohmic contact islands 165 are sequentially formed on gate lines 121 and storage electrode lines 131.

A plurality of data lines 171 including source electrodes 173 and end portions 179, a plurality of drain electrodes 175, and a plurality of isolated metal pieces 178 are formed on ohmic contacts 161 and 165, and a protective layer 180 is formed thereon. A plurality of contact holes 181, 182, 183a, 183b, and 185 are formed on the protective layer 180 and the gate insulating layer 140. A plurality of pixel electrodes 191 including cutouts 91 to 92b, a plurality of overpasses 83, and a plurality of contact assistants 81 and 82 are formed on the protective layer 180, and an alignment layer 11 is formed thereon.

In the common electrode panel 200, a light blocking member 220, a plurality of color filters 230, a cover film 250, a common electrode 270, a plurality of slope members 71 to 72b, and an alignment layer 21 are formed on an insulating substrate 210.

Unlike the liquid crystal display shown in FIGS. 1 to 4, semiconductor stripes 151 have planar shapes that are substantially equal to shapes of data lines 171, drain electrodes 175, and the underlying ohmic contacts 161 and 165. Semiconductor stripes 151 have exposed portions that do not cover regions between the source electrodes 173 and drain electrodes 175.

Furthermore, the TFT array panel 100 includes a plurality of semiconductor islands (not shown) and a plurality of ohmic contact islands (not shown) disposed thereon, which are disposed on the metal pieces 178.

A manufacturing method of the TFT array panel according to the embodiment simultaneously forms data lines 171, drain electrodes 175, the metal pieces 178, the semiconductors 151, and ohmic contacts 161 and 165 using one photolithography process.

A semiconductor layer, an ohmic contact layer, and a data metal layer are sequentially deposited on the gate insulating layer 140, and a photosensitive film having different thicknesses according to positions thereof are formed. After that, by using the photosensitive film as an etch mask, the semiconductor layer, the ohmic contact layer, and the data metal layer are etched, so that the thin film transistor panel is fabricated. Here, the photosensitive film for the photolithography process has position-dependent thickness, and in particular, it has first and second portions with decreased thickness. The first portions are located on wire areas that will be occupied by data lines 171, drain electrodes 175, and the metal pieces 172, and the second portions are located on channel areas of TFTs.

The position-dependent thickness of the photoresist is obtained by several techniques, for example by providing translucent areas on the exposure mask as well as transparent areas and light blocking opaque areas. The translucent areas may have a slit pattern, a lattice pattern, or be a thin film(s) with intermediate transmittance or intermediate thickness. When using a slit pattern, it is preferable that the width of the slits or the distance between the slits is smaller than the resolution of a light exposer used for the photolithography. Another example is to use a reflowable photoresist. In detail, once a photoresist pattern made of a reflowable material is formed by using a normal exposure mask with only transparent areas and opaque areas, it is subject to a reflow process to flow onto areas without the photoresist, thereby forming thin portions.

By using the photoresist pattern as an etch mask, a data metal layer, an ohmic contact layer, and a semiconductor layer are sequentially etched to roughly form a shape of data wire lines. Next, an ashing process is performed on the photosensitive film to remove a second portion, and by using a remaining first portion as an etch mask, the exposed data metal layer and the exposed ohmic contact layer are etched, so that a channel portion of the thin film transistor is formed.

As a result, the manufacturing process is simplified by omitting a photolithography step.

Many of the above-described features of the LCD shown in FIGS. 13 and 14 may be appropriate to the TFT array panel shown in FIGS. 1 to 12.

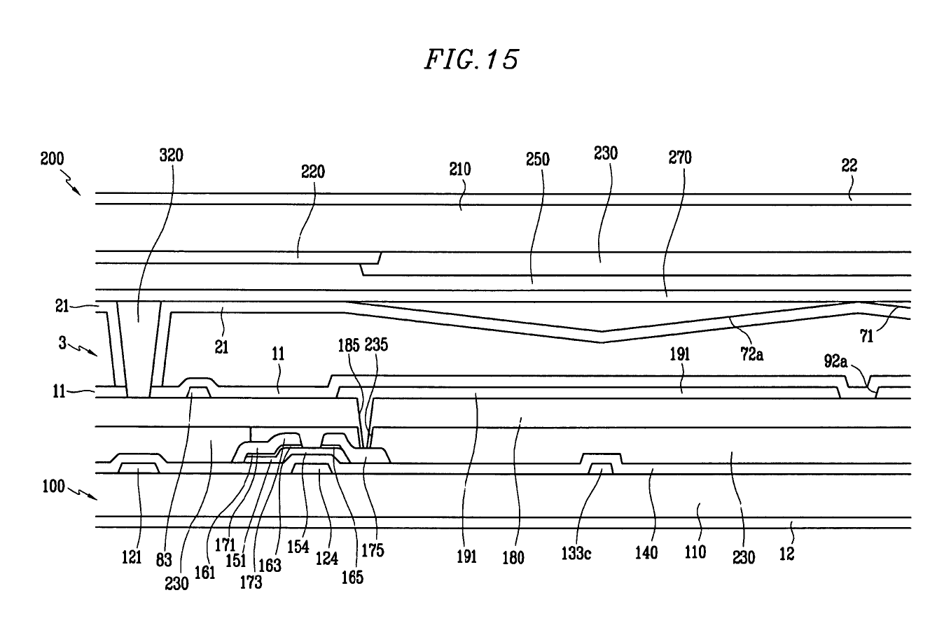

An LCD according to another embodiment of the present invention will be described in detail with reference to FIG. 15.

FIG. 15 is a cross-sectional view showing the liquid crystal display according to another exemplary embodiment of the present invention taken along line VIII-VIII of FIG. 7.

Referring to FIG. 15, an LCD according to this embodiment also includes a TFT array panel 100, a common electrode panel 200, an LC layer 3, a plurality of columnar spacers 320 interposed between the panels 100 and 200, and a pair of polarizers 12 and 22 attached on outer surfaces of the panels 100 and 200, respectively.

Layered structures of the panels 100 and 200 according to this embodiment are almost the same as those shown in FIGS. 7 and 8.

Regarding the TFT array panel 100, a plurality of gate lines 121 including gate electrodes 124 and end portions 129 and a plurality of storage electrode lines 131 with a plurality of storage electrodes 133a to 133d and a plurality of connection portions 133e are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179, a plurality of drain electrodes 175, and a plurality of isolated metal pieces 178 are formed on ohmic contacts 161 and 165, and a passivation layer 180 is formed thereon. A plurality of contact holes 181, 182, 183a, 183b, and 185 are provided at passivation layer 180 and the gate insulating layer 140. A plurality of pixel electrodes 191 having a plurality of cutouts 91-92b, a plurality of contact assistants 81 and 82, and a plurality of overpasses 83 are formed on passivation layer 180, and an alignment layer 11 is coated thereon.

Regarding the common electrode panel 200, a light blocking member 220, an overcoat 250, a common electrode 270, a plurality of slope members 71 to 72b, and an alignment layer 21 are formed on an insulating substrate 210.

Unlike the liquid crystal display shown in FIGS. 7 and 8, color filters are not provided to the common electrode panel 200. Rather, a plurality of color filters 230 are formed under passivation layer 180 of the thin film transistor panel 100.

The color filters 230 extend along rows of pixel electrodes 191 in a shape of a stripe in the longitudinal direction. The boundary between the two color filters 230 matches with the data line 171. However, the color filters 230 may be separated from each other or overlap each other to prevent light leakage between pixel electrodes 191, similar to a light blocking member. Thus, in the case wherein the color filters 230 overlap with each other, the light blocking member 220 on the common electrode panel 200 may be omitted.

Through holes 235 though which the contact holes 185 pass are formed on the color filters 230, and diameters of the through holes 235 are larger than those of the contact holes 185. The color filters 230 are not provided to peripheral regions where the end portions 129 of gate lines 121 and the end portions 179 of data lines 171 are disposed.

The liquid crystal displays shown in FIG. 15 may employ the features of the liquid crystal displays shown in FIGS. 1 to 14.

For example, the features of the liquid crystal display according to the present exemplary embodiment may be employed by a liquid crystal display having a structure where different voltages are applied to two sub-pixel electrodes divided from one pixel electrode.

Now, a liquid crystal display according to another exemplary embodiment of the present invention will be described in detail with reference to FIGS. 16 to 19.

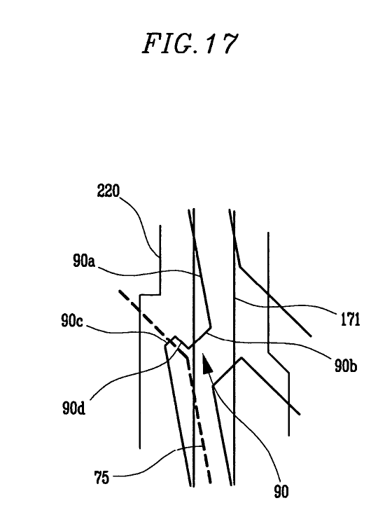

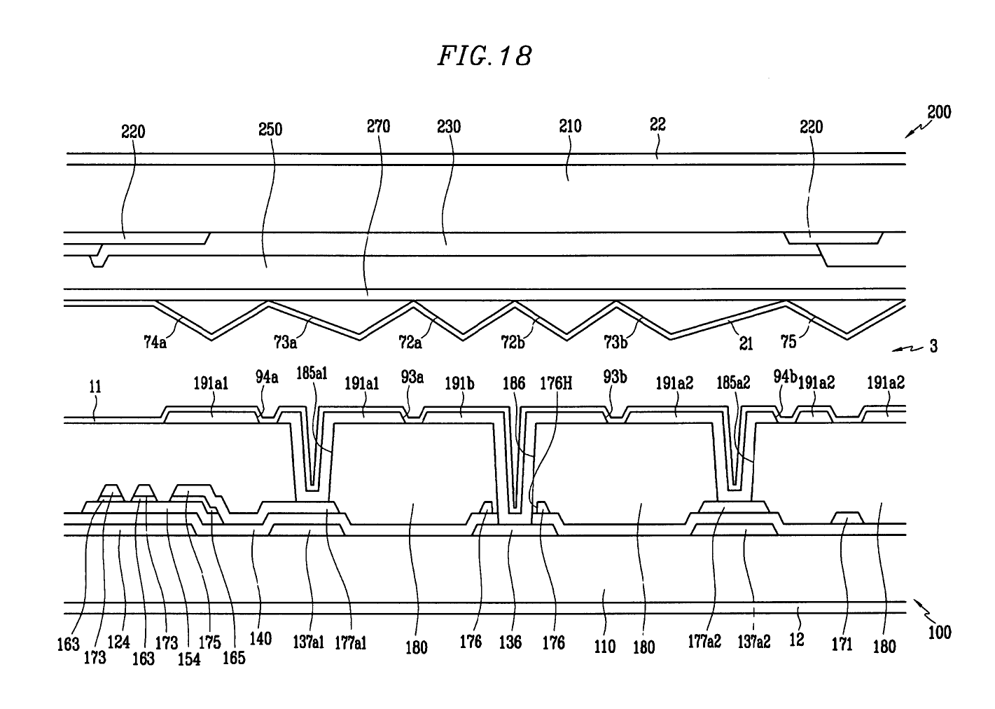

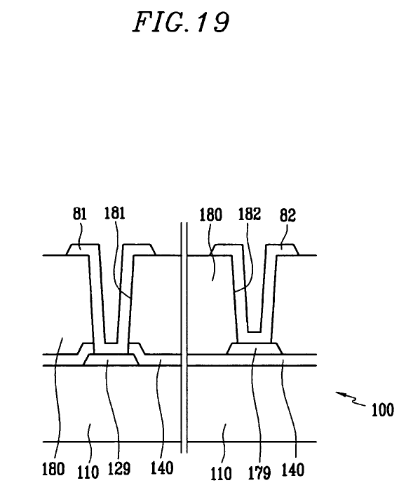

FIG. 16 is a view showing a layout of a liquid crystal display according to an exemplary embodiment of the present invention, FIG. 17 is an enlarged view showing a portion of the liquid crystal display of FIG. 16, FIG. 18 is a cross-sectional view showing the liquid crystal display taken along line XVIII-XVIII of FIG. 16, and FIG. 19 is a cross-sectional view showing the liquid crystal display taken along line XIX-XIX of FIG. 16.

Referring to FIGS. 16 to 19, the liquid crystal display includes a thin film transistor panel 100 and a common electrode panel 200 that face each other, and a liquid crystal layer 3 interposed between the panels 100 and 200.

Firstly, the thin film transistor panel 100 will be described in detail.

A plurality of gate conductors including a plurality of gate lines 121, a plurality of storage electrode lines 131, and a plurality of capacitive electrodes 136 are disposed on an insulating substrate 110 made of transparent glass or a plastic material.

Gate lines 121 for transmitting gate signals mainly extend in the transverse direction. Gate lines 121 include a plurality of gate electrodes 124 that protrude upwardly and end portions 129 that have wide areas for connection to other layers or external driver circuits. A gate driver circuit that generates the gate signals may be mounted on a flexible printed circuit film attached on substrate 110, it may be directly mounted on substrate 110, or it may be integrated with substrate 110. In the case where the gate driver circuit is integrated with substrate 110, gate lines 121 are extended to be directly connected to the gate driver circuit.

Storage electrode lines 131 that are applied with predetermined voltages include lower and upper stem lines 131a1 and 131a2 that extend substantially in parallel to gate lines 121. Each of storage electrode lines 131 is disposed between two adjacent gate lines 121. The lower stem line 131a1 is closer to the lower one of the two gate lines 121, and the upper stem line 131a2 is closer to the upper one of the two gate lines 121. The lower and upper stem lines 131a1 and 131a2 include lower and upper storage electrodes 1371a and 1371b that are enlarged downwardly and upwardly.

The capacitive electrode 136 has a shape of a rectangle that is elongated in the transverse direction. The capacitive electrode 136 is separated from the gate line 121 and the storage electrode line 131, and is disposed between a pair of the lower and upper storage electrodes 1371a and 1371b and separated by substantially the same distance from the lower and upper storage electrodes 1371a and 1371b. In addition, the capacitive electrode 136 is also separated by the same distance from the two adjacent gate lines 121. However, various shapes and arrangement may be used for storage electrode lines 131.

The gate conductors 121, 131, and 136 are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti or Ta. Gate lines 121 and storage electrode lines 131 may have a multi-layered structure including two films having different physical characteristics. One of the two films is preferably made of a low resistivity metal including an Al-containing metal, a Ag-containing metal, and a Cu-containing metal for reducing signal delay or voltage drop in gate lines 121 and storage electrode lines 131. The other film is preferably made of a material such as a Mo-containing metal, Cr, Ta or Ti, which has good physical, chemical, and electrical contact characteristics with other materials such as indium tin oxide (ITO) or indium zinc oxide (IZO). Good examples of the combination of the two films are a lower Cr film and an upper Al—Nd alloy film, and a lower Al (alloy) film and an upper Mo (alloy) film. However, gate lines 121 and storage electrode lines 131 may be made of various metals and conductive materials.

Side surfaces of the gate conductors 121, 131, and 136 are slanted with respect to a surface of substrate 110, at an angle in a range of about 30° to about 80°.

A gate insulating layer 140 made of silicon nitride (SiNₓ) or silicon oxide (SiOₓ) is formed on the gate conductors 121, 131, and 136.

A plurality of semiconductor islands 154 made of hydrogenated amorphous silicon (abbreviated to a-Si) or polysilicon are formed on the gate insulating film 140. The semiconductor members 154 are disposed on the gate electrodes 124 and include expansion portions covering boundaries of gate lines 121. In addition, semiconductor islands may be separately formed to cover boundaries of storage electrode lines 131.

A plurality of ohmic contact islands 163 and 165 are formed on the semiconductor islands 154. The ohmic contacts 163 and 165 may be made of silicide or n+hydrogenated amorphous silicon which is heavily doped with n-type impurities such as phosphorus (P). A pair of the ohmic contacts 163 and 165 are disposed on the semiconductor 154.

Side surfaces of the semiconductor members 154 and the ohmic contacts 163 and 165 are also slanted with respect to the surface of the substrate 100 at an angle in a range of about 30° to about 80°.

A plurality of data conductors including a plurality of data lines 171 and a plurality of drain electrodes 175 are formed on the ohmic contacts 163 and 165 and the gate insulating layer 140.

Data lines 171 for transmitting data signals mainly extend in the longitudinal direction to intersect gate lines 121 and storage electrode lines 131. Data lines 171 include a plurality of source electrodes 173 that protrude toward the gate electrodes 124 and end portions 179 that have wide areas for connection to other layers or external driver circuits. A data driving circuit (not shown) for generating the data signals may be mounted on an FPC film (not shown), which may be attached to substrate 110, directly mounted on substrate 110, or integrated with substrate 110. Data lines 171 may extend to be connected to a driving circuit that may be integrated with substrate 110.

Drain electrodes 175 are separated from data lines 171. Drain electrodes 175 include a bar-shaped end portion that faces a source electrode 173 with respect to the gate electrode 124 interposed therebetween. The bar-shaped end portion is partially surrounded by the U-shaped source electrode 173.

Each drain electrode 175 includes lower, upper, and central expansion portions 177a1, 177a2, and 176, and a pair of connection portions 178a1 and 178a2 that connect the expansion portions. The expansion portions 177a1, 177a2, and 176 have a shape of a rectangle that is elongated in the transverse direction. The connection portions 178a1 and 178a2 connect the expansion portions 177a1, 177a2, and 176 at both sides thereof, and are substantially parallel to data lines 171.

The lower and upper expansion portions 177a1 and 177a2 overlap the lower and upper storage electrodes 137a1 and 137a2.

The central expansion portion 176 overlaps the capacitive electrode 136. Hereinafter, the central expansion portion 176 is referred to as a coupling electrode. A contact hole 176H is formed at the right end portion of the coupling electrode 176. The shape of the coupling electrode 176 is formed to be substantially the same as that of the capacitive electrode 136.

A gate electrode 124, a source electrode 173, and a drain electrode 175 along with a semiconductor 154 form a TFT having a channel formed in the semiconductor 154 disposed between the source electrode 173 and the drain electrode 175.

The data conductors 171, 175, and 176 are preferably made of a refractory metal such as Cr, Mo, Ti, Ta, or alloys thereof. However, they may also have a multilayered structure including a low-resistivity film (not shown) and a good-contact film (not shown). A good example of the combination is a lower Mo film, an intermediate Al film, and an upper Mo film, as well as the above-described combinations of a lower Cr film and an upper Al—Nd alloy film and a lower Al film and an upper Mo film. However, the data conductors 171, 175, and 176 may be made of various metals or conductors.

As an example, side surfaces of the data conductors 171, 175, and 176 are slanted with respect to the surface of substrate 110 at an angle ranging from about 30° to about 80°.

The ohmic contacts 163 and 165 are interposed only between the underlying semiconductors 154 and the overlying data conductors 171 and 175 and reduce contact resistance therebetween. The extension portions of the semiconductors disposed on gate lines 121 allows the profile of surfaces to be smoothed, so that disconnection of data lines 171 can be prevented. The semiconductors 154 have exposed portions uncovered by the data conductors 171 and 175 in addition to portions disposed between the source electrodes 173 and drain electrodes 175.

A passivation layer 180 is formed on the data conductors 171 and 175 and the exposed portions of the semiconductors 154. Passivation layer 180 is made of an inorganic insulating material or an organic insulating material, and a surface thereof may be planarized.

A plurality of contact holes 182 that expose end portions 179 of data lines 171 and a plurality of contact holes 185a1 and 185a2 that expose lower and upper expansion portions 177a1 and 177a2 of drain electrodes 175, respectively, are formed on the protective layer 180. In addition, a plurality of contact holes 181 that expose end portions 129 of gate lines 121 and a plurality of contact holes 186 that expose the capacitive electrodes 136 through contact holes 176H of coupling electrodes 176 are formed on the protective layer 180 and the gate insulating layer 140.

A plurality of pixel electrodes 191 and a plurality of contact assistants 81 and 82 are formed on the protective layer 180. The components may be made of a transparent conductive material such as ITO or IZO, or a reflective metal such as aluminum (Al), silver (Ag), chromium (Cr), and alloys thereof.

Each pixel electrode 191 has a pair of first primary edges 193 and 194 facing each other and second primary edges that are connected to the first primary edges 193 and 194 and include a plurality of sawteeth 90 and lower edges 90c connecting the sawteeth 90. Each of the sawteeth 90 includes first and second slanted edges 90a and 90d that are slanted with respect to the first primary edges 193 and 194 and an upper edge 90b. The first primary edges 193 and 194 are parallel to gate lines 121. The first primary edges 193 and 194 and the second primary edges constitute an approximate rectangle. The pixel electrode 191 has the four chamfered corners that form an angle of about 45° with respect to gate lines 121. The first slanted edge 90a partially overlaps the data line 171. The first slanted edges 90a of two adjacent pixel electrodes 191 are disposed to face each other in parallel to each other.

Each of pixel electrodes 191 includes lower and upper sub-pixel electrodes 191a1 and 191a2 and a central sub-pixel electrode 191b, which are divided by the lower and upper gaps 93a and 93b. The lower and upper gaps 93a and 93b extend substantially in the slanted directions from the left side to the right side of the pixel electrode 191. Accordingly, the central sub-pixel electrode 191b has a shape of an isosceles trapezoid, and the lower and upper sub-pixel electrodes 191a1 and 191a2 have a shape of a rectangular trapezoid. The lower and upper gaps 93a and 93b are perpendicular to each other with slanted angles of about 45° with respect to the gate line 121.

The lower and upper sub-pixel electrodes 191a1 and 191a2 are connected to the lower and upper expansion portions 177a1 and 177a2 of the drain electrode 175 through the contact holes 185a1 and 185a2.

The central sub-pixel electrode 191b is connected to the capacitive electrode 136 through the contact hole 186, and overlaps a coupling electrode 176. The central sub-pixel electrode 191b and the capacitive electrode 136 together with the coupling electrode 176 constitute a coupling capacitor.

A central cutout 91 and first upper and lower slanted cutouts 92a and 92b are formed in the central sub-pixel electrode 191b. A second lower slanted cutout 94a is formed in the lower sub-pixel electrode 191a1. A second upper slanted cutout 94b is formed in the upper sub-pixel electrode 191a2. The cutouts 91, 92a, 92b, 94a, and 94b divide the sub-pixel electrodes 191b, 191a1, and 191a2 into a plurality of sub-areas. The pixel electrode 191 including the cutouts 91, 92a, 92b, 94a, and 94b and the gaps 93a and 93b (hereinafter, referred as cutouts) have inversion symmetry with respect to the capacitive electrode 136.

The lower and upper slanted cutouts 92a to 94b extend substantially in the slanted directions from the right corners, the lower side, or the upper side to the right side of the pixel electrode 191. The lower and upper slanted cutouts 92a to 94b extend perpendicularly to each other with slanted angles of about 45° with respect to the gate line 121. Each of the lower and upper slanted cutouts 92a, 92b, 94a, and 94b has an inlet at the right or left side of the pixel electrode 191. The inlets may be connected to the concave portions 90c.

The first slanted edges 90a of the sawteeth 90 of the second primary edges have an obtuse angle with respect to the slanted cutouts 92a to 94a, and the second slanted edges 90d thereof are substantially parallel to the slanted cutouts 92b to 94b.

The central cutout 91 extends along the storage electrode line 131 and has an inlet toward the left side of the pixel electrode 191. The inlet of the central cutout 91 has a pair of slanted edges that are substantially parallel to the lower cutouts 92a to 94a and the upper cutouts 92b-94b, respectively.

The number of cutouts and the number of partitions may vary according to design factors such as, for example, the size of pixel electrodes 191a1, 191a2, and 191b, the ratio of lengths of the transverse and longitudinal sides of pixel electrodes 191a1, 191a2, and 191b, and the types or characteristics of the liquid crystal layer 3.

The contact assistants 81 and 82 are connected to the end portion 129 of the gate line 121 and the end portion 179 of the data line 171 through the contact holes 181 and 182, respectively.

Now, the common electrode panel 200 will be described in detail.

A light blocking member 220 is formed on the insulating substrate 210 made of transparent glass or a plastic material. The light blocking member 220 includes line-shaped portions 211 corresponding to data lines 171, enlarged portions 222 formed by enlarging some portions of the light blocking member 220, and plane-shaped portions 223 corresponding to the thin film transistors. The light blocking member 220 prevents light leakage between pixel electrodes 191 and defines opening regions facing the pixel electrodes. However, the light blocking member 220 may further include a plurality of opening portions facing pixel electrodes 191 and that have substantially the same shape as pixel electrodes 191.

A plurality of color filters 230 are formed on the substrate 210. Most portions of the color filters 230 are disposed in regions surrounded by the light-blocking member 220. In addition, the color filters 230 extend along rows of pixel electrodes 191 in the longitudinal direction. Each of the color filters 230 can display one of primary colors such as red, green, and blue.

An overcoat 250 is formed on the color filters 230 and the light-blocking member 220. The overcoat 250 may be made of an (organic) insulating material, and it prevents the color filters 230 from being exposed and provides a planarized surface. The overcoat 250 may be omitted.

A common electrode 270 is formed on the overcoat 250.

A plurality of slope members 71, 72a, 72b, 73a, 73b, 74a, 74b, and 75 are formed on the common electrode 270.

One slope member set 71-75 faces one pixel electrode 191 and includes a central slope member 71, first to third lower slanted slope members 72a, 73a, and 74a, first to third upper slanted slope members 72b, 73b, and 74b, and a connection slope member 75. The slope members 71, 72a, 72b, 73a, 73b, 74a, and 74b are disposed between the adjacent cutouts 91, 92, 93a, 93b, 94a, 94b, 95a, and 95b of the pixel electrode 191 or between the cutouts 91, 92, 93a, 93b, 94a, 94b, 95a, and 95b and the chamfered edge of the pixel electrode 191. In addition, each of the slope members 71, 72a, 72b, 73a, 73b, 74a, and 74b extends substantially in parallel to the lower cutouts 93a, 94a, and 95a or upper cutouts 93b, 94b, and 95b of the pixel electrode 191, and includes at least one slanted portion.

The first lower and upper slanted slope members 72a and 72b extend substantially from the right side to the left side of the pixel electrode 191. The second lower and upper slanted slope members 73a and 73b extend substantially from the right side to the upper and lower left corners of the pixel electrode 191, respectively. The third lower and upper slanted slope members 74a and 74b extend substantially from the right side to the lower and upper sides of the pixel electrode 191, respectively. The third lower and upper slanted slope members 74a and 74b include terminated transverse portions that extend from the ends of the third lower and upper slanted slope members 74a and 74b to overlap the lower and upper sides of the pixel electrode 191. The terminated transverse portion has an obtuse angle with respect to the slanted slope members 74a and 74b.

The central slope member 71 includes a central transverse portion and a pair of slanted portions. The central transverse portion extends substantially from the right side of the pixel electrode 191 along the storage electrode line 131 in the left direction. A pair of the slanted portions extend substantially in parallel to the lower and upper slope members 72a, 72b, 73a, 73b, 74a, and 74b from the end of the central transverse portion to the left side of the pixel electrode 191.

One end of one slanted portion of the central slope member 71 and one end of the second lower slope member 73a of the adjacent pixel electrode are connected with one of the connection portions 75. One end of the other slanted portion of the central slope member 71 and one end of the second upper slope member 73b of the adjacent pixel electrode are connected with one of the connection portions 75. One end of the first lower slanted slope member 72a and one end of the third lower slanted slope member 74a of the adjacent pixel electrode are connected with one of the connection portions 75. One end of the first upper slanted slope member 72b and one end of the third upper slanted slope member 74b of the adjacent pixel electrode are connected with one of the connection portions 75. The connection portions 75 are parallel to the first slanted edges 90a of the pixel electrode 191 and located at portions corresponding to the data line 171.

Alignment films 11 and 21 are coated on inner surfaces of the panels 100 and 200, respectively. The alignment films 11 and 21 may be vertically-aligned films. Polarizers (not shown) are disposed on outer surfaces of the panels 100 and 200, respectively. The transmission axes of the two polarizers are perpendicular to each other, and one of the transmission axes is preferably parallel to gate lines 121. In the case of a reflective liquid crystal display, one of the two polarizers may be omitted.

The liquid crystal display according to the present embodiment may further include a phase retardation film for compensating for retardation of the liquid crystal layer 3. The phase retardation film has birefringence and has a function of inversely compensating for the birefringence of the liquid crystal layer 3.

The liquid crystal display may include a backlight unit for supplying light to the polarizers, the phase retardation film, the panels 100 and 200, and the liquid crystal layer 3.

The liquid crystal layer 3 has a negative dielectric anisotropy, and the liquid crystal molecules 31 of the liquid crystal layer 3 are aligned so that the major axes thereof are perpendicular to the surfaces of the two panels 100 and 200 when no electric field is applied to the liquid crystal molecules. As a result, incident light cannot pass through the perpendicular polarizers and is thus blocked.

In the liquid crystal displays shown in FIGS. 16 to 19, opaque members such as storage electrode lines 131, the capacitive electrodes 136, the expansion portions 177a1, 177a2, and 176 of drain electrodes 175, and the connection portions 178a1 and 178a2 and transparent members such as pixel electrodes 191 including the cutouts 91 to 94b are symmetrically disposed with respect to the capacitive electrodes 136 that are separated by the same distance from the adjacent two gate lines 121.

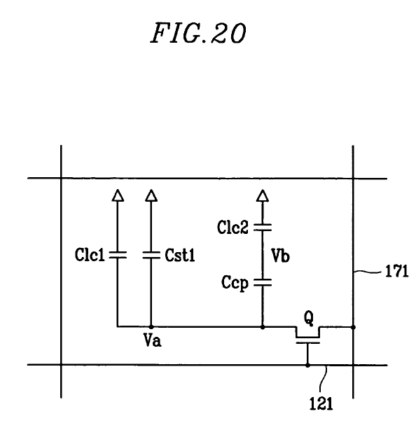

Now, the liquid crystal display will be described in more detail with respect to FIG. 20.

FIG. 20 is a schematic equivalent circuit diagram of a pixel of the liquid crystal display shown in FIG. 16.

Referring to FIG. 20, one pixel of the liquid crystal display includes a thin film transistor Q, a first sub-pixel electrode including a first liquid crystal capacitor C_{LC} a and a storage capacitor C_{ST}, a second sub-pixel electrode including a second liquid crystal capacitor C_{LC}b, and a coupling capacitor Ccp.

The first liquid crystal capacitor C_{LC}a includes the upper and lower sub-pixel electrodes 191a1 and 191a2 as one port thereof, the common electrode 270 as another port thereof, and the liquid crystal layer 3 interposed between the two ports as a dielectric member. Similarly, the second liquid crystal capacitor C_{LC}b includes the central sub-pixel electrode 191b as one port thereof, a corresponding portion of the common electrode 270 as another port thereof, and the liquid crystal layer 3 interposed between the two ports as a dielectric member.

The storage capacitor C_{ST} includes the lower and upper expansion portions 177a1 and 177a2 of the drain electrode 175 as one port thereof, the lower and upper storage electrodes 137a1 and 137a2 as another port thereof, and a corresponding portion of the gate insulating layer 140 interposed between the two ports as a dielectric member. The coupling capacitor C_{CP} includes the central sub-pixel electrode 191b and the capacitive electrode 136 as one port thereof, the coupling electrode 176 as another port thereof, and corresponding portions of the proactive layer 180 and the gate insulating layer 140 interposed between the two ports as a dielectric member.

The first liquid crystal capacitor C_{LC}a and the storage capacitor C_{ST} are connected to the drain electrode of the thin film transistor Q, and the coupling capacitor C_{CP} is connected between the thin film transistor Q and the second liquid crystal capacitor C_{LC}b. The common electrode 270 is applied with a common voltage Vcom, and the storage electrode line 131 may also be applied with the common voltage Vcom.

The thin film transistor Q applies a data voltage from the data line 171 to the first liquid crystal capacitor C_{LC}a and the coupling capacitor C_{CP} according to a gate signal from the gate line 121. The coupling capacitor C_{CP} changes a size of the voltage and transmits the voltage to the second liquid crystal capacitor C_{LC}b.

If the storage electrode line 131 is applied with the common voltage Vcom, and if the electrostatic capacitances of the capacitors C_{LC}a, C_{ST}, C_{LC}b, and Ccp are denoted by C_{LC}a, C_{ST}, C_{LC}b, and Ccp, a voltage Va charged in the first liquid crystal capacitor C_{LC}a and a voltage Vb charged in the second liquid crystal capacitor C_{LC}b have a relationship as follows.
Vb=Va[Ccp/(Ccp+C_{LC}b)]

Since a value of Ccp/(Ccp+C_{LC}b) is less than 1, the voltage Vb charged in the second liquid crystal capacitor C_{LC}b is always smaller than the voltage Va charged in the first liquid crystal capacitor C_{LC}a. Even in a case where the voltage of the storage electrode line 131 is not the common voltage Vcom, the relationship is satisfied.

When the voltage difference between the two ports of the first or second liquid crystal capacitor C_{LC}a or C_{LC}b is generated, an electric field is generated in the liquid crystal layer 3 in a direction substantially perpendicular to the panels 100 and 200. In response to the electric field, the liquid crystal molecules have a tendency to change the major axis direction to be perpendicular to the direction of the electric field. According to the degree of the tilted angle of the liquid crystal molecules, polarization of light passing through the liquid crystal layer 3 changes. The change in the polarization results in a change in transmittance of the light due to the polarizers 12 and 22, so that an image is displayed on the liquid crystal display.

The tilted angle of the liquid crystal molecules varies according to the strength of the electric filed. Since the voltage Va charged in the first liquid crystal capacitor C_{LC}a is different from the voltage Vb charged in the second liquid crystal capacitor C_{LC}b, the tilted angles of the liquid crystal molecules in the first and second sub-pixels are different from each other. As a result, the brightnesses of the two sub-pixel electrodes are different from each other. Accordingly, by adjusting the voltage Va charged in the first liquid crystal capacitor C_{LC}a and the voltage Vb charged in the second liquid crystal capacitor C_{LC}b, the brightness of the image seen from a side of the liquid crystal display can be closest to the brightness of the image seen from the front of the liquid crystal display, thereby improving the side viewing angle.

The ratio of the voltage Va charged in the first liquid crystal capacitor C_{LC}a and the voltage Vb charged in the second liquid crystal capacitor C_{LC}b can be adjusted by changing the electrostatic capacitance of the coupling capacitor C_{CP}. The electrostatic capacitance of the coupling capacitor C_{CP} can be changed by adjusting the overlapping area and distance between the second sub-pixel electrode 191b, the capacitive electrode 136, and the coupling electrode 176. For example, by removing the capacitive electrode 136 and disposing the coupling electrode 176 at the position where the capacitive electrode 136 is removed, the distance between the coupling electrode 176 and the second sub-pixel electrode 191b can increase. For example, the voltage Vb charged in the second liquid crystal capacitor C_{LC}b may be about 0.6 to about 0.8 times larger than the voltage Va charged in the first liquid crystal capacitor C_{LC}a.

In contrast, the voltage Vb charged in the second liquid crystal capacitor C_{LC}b may be designed to be larger than the voltage Va charged in the first liquid crystal capacitor C_{LC}a by pre-charging the second liquid crystal capacitor C_{LC}b with a predetermined voltage such as the common voltage Vcom.

Preferably, the ratio of areas of the lower and upper sub-pixel electrodes 191a1 and 191a2 and an area of the central sub-pixel electrode 191b is in a range of from about 1:0.85 to about 1:1.15. The number of sub-pixel electrodes of each of the sub-pixels may vary.

In addition, by providing the sawteeth to the side of the pixel electrode 191 adjacent to the data line 171, the secondary electric field generated between the adjacent pixel electrodes 191 can control the alignment of the liquid crystal molecules 31 in the sub-areas. Further, by providing the connection portions 75 at the positions corresponding to the regions where the first slanted edges 90a of the adjacent two pixel electrodes 191 face each other, the alignment of the liquid crystal molecules 31 in the sub-areas can be controlled.

The liquid crystal display shown in FIGS. 16 to 20 may employ the features of the liquid crystal display shown in FIGS. 1 to 15.

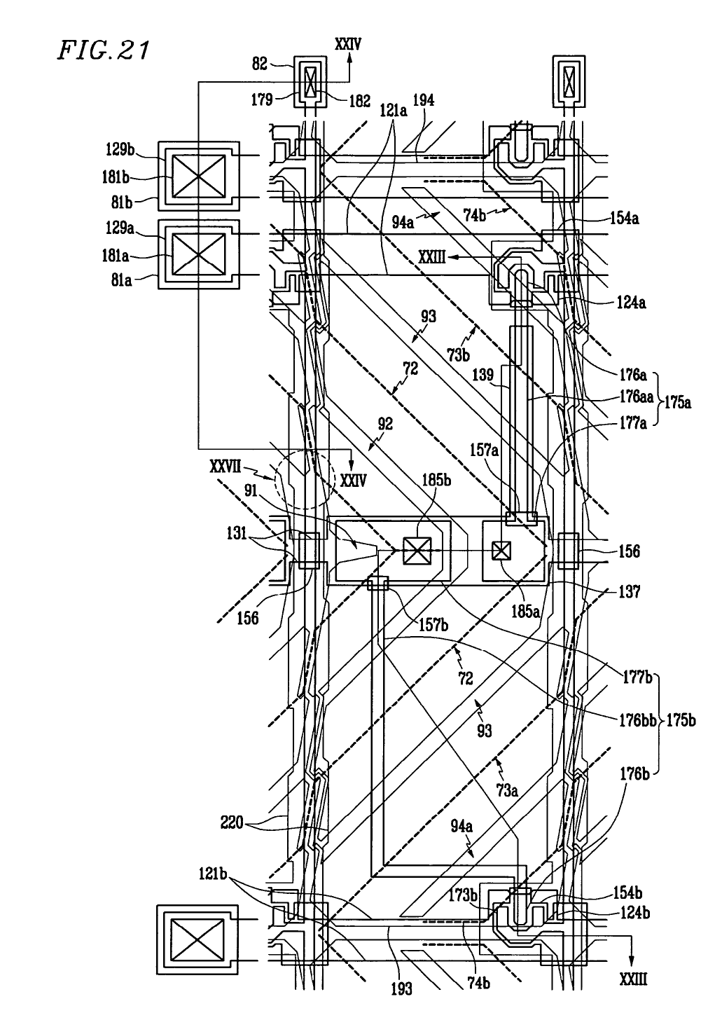

Now, a liquid crystal displays according to another exemplary embodiment of the present invention will be described in detail with reference to FIGS. 21 to 24.

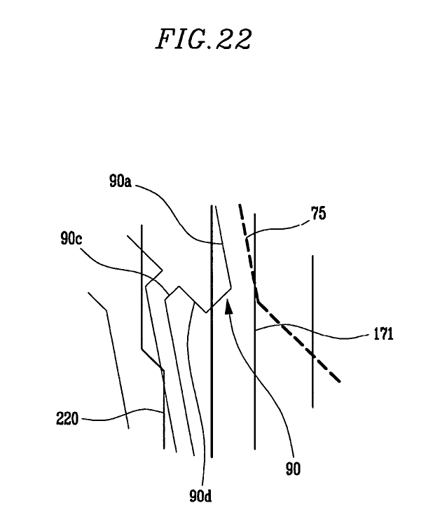

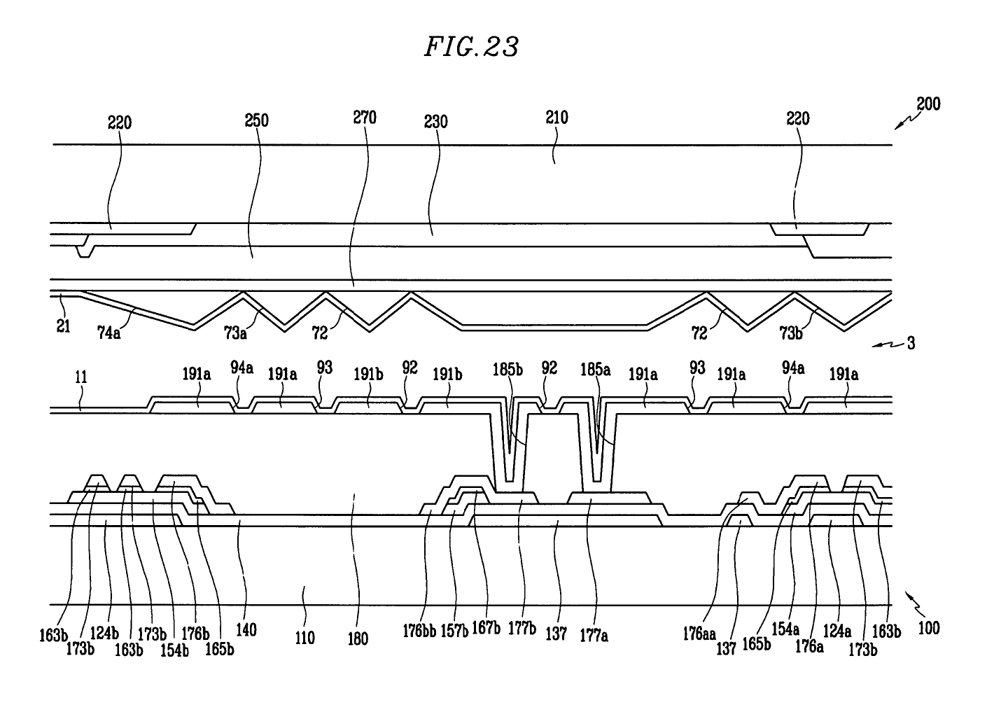

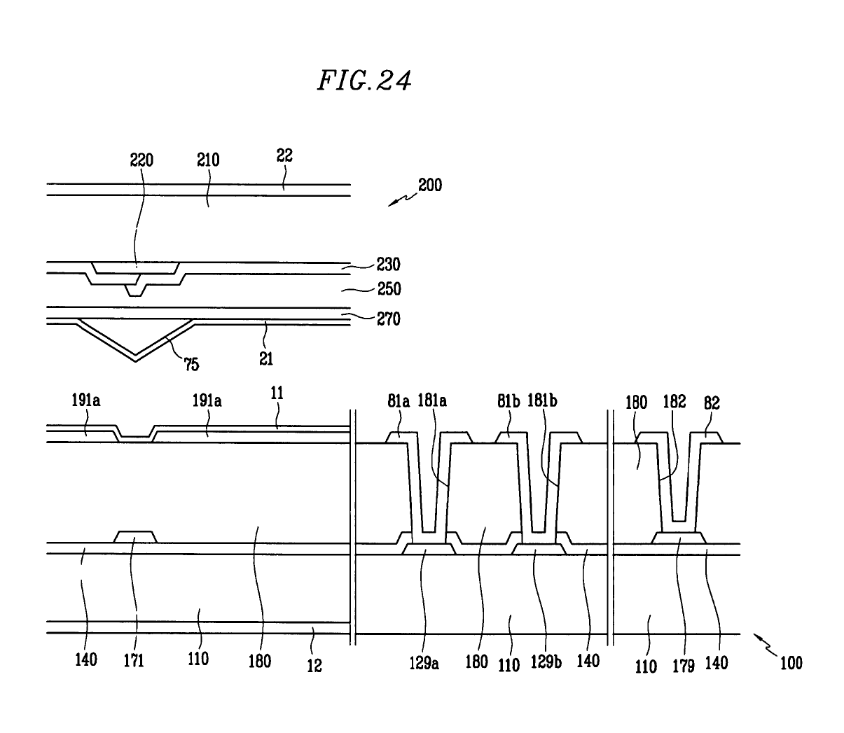

FIG. 21 is a view showing a layout of a liquid crystal display according to an exemplary embodiment of the present invention, FIG. 22 is an enlarged view showing a portion of the liquid crystal display of FIG. 21, FIG. 23 is a cross-sectional view showing the liquid crystal display taken along line XXIII-XXIII of FIG. 21, and FIG. 24 is a cross-sectional view showing the liquid crystal display taken along line XXIV-XXIV of FIG. 21.

Referring to FIGS. 21 to 24, the liquid crystal display includes a thin film transistor panel 100 and a common electrode panel 200 that face each other, and a liquid crystal layer 3 interposed between the panels 100 and 200.

Firstly, the thin film transistor panel 100 will be described in detail.

A plurality of gate conductors including a plurality of pairs of first and second gate lines 121a and 121b and a plurality of storage electrode lines 131 are disposed on an insulating substrate 110 made of transparent glass or a plastic material.

The first and second gate lines 121a and 121b for transmitting gate signals mainly extend in the transverse direction, and are located above and below the storage electrode line 131, respectively.

The first gate line 121a include a first gate electrode 124a that protrudes downwardly and an end portion 129a that is disposed in the left side and has an wide area for connection to other layers or external driver circuits.

The second gate line 121b includes a second gate electrode 124b that protrudes upwardly and an end portion 129b that is disposed in the left side and has a wide area for connection to other layers or external driver circuits. Alternatively, the end portions 129a and 129b may be disposed at the right side, or the end portions 129a and 129b may be disposed at different sides.

Storage electrode lines 131 that are applied with predetermined voltages extend substantially in parallel to gate lines 121. Each of storage electrode lines 131 is disposed between the adjacent first and second gate lines 121a and 121b. The storage electrode line 131 is slightly closer to the first gate line 121a than the second gate line 121b and is separated by substantially the same distance from the adjacent two second gate lines 121b. Each of storage electrode lines 131 includes a storage electrode 137 that is enlarged upwardly and downwardly. The storage electrode 137 has a shape of an approximate rectangle and is symmetrical with respect to the storage electrode line 131. However, various shapes and arrangements may be used for storage electrode lines 131 and the storage electrodes 137.

Side surfaces of the gate conductors 121a, 121b, and 131 are slanted with respect to a surface of substrate 110, at an angle in a range of about 30° to about 80°.

A gate insulating layer 140 made of silicon nitride (SiNₓ) or the like is formed on the gate conductors 121a, 121 b, and 131.

A plurality of island-shaped semiconductors 154a, 154b, 156, 157a, and 157b made of hydrogenated amorphous silicon (abbreviated to a-Si) or polysilicon are formed on the gate insulating film 140. The semiconductors 154a and 154b are disposed on the gate electrodes 124a and 124b. The semiconductors 156 cover boundaries of gate lines 121. The semiconductors 157a and 157b partially overlap the boundary lines of the storage electrode 137.

A plurality of island-shaped ohmic contacts 163a, 163b, 165a, 165b, and 167b are formed on semiconductors 154a, 154b, and 157b. A plurality of island-shaped ohmic contacts are formed on semiconductors 156 and 157a. The ohmic contacts 163a, 163b, 165a, 165b, and 167b may be made of silicide or n+ hydrogenated amorphous silicon which is heavily doped with n-type impurities such as phosphorus (P). Pairs of the ohmic contacts 163a and 165b and the ohmic contacts 163b and 165b are disposed on the semiconductors 154a and 154b, respectively.

Side surfaces of the semiconductors 154a, 154b, 156, 157a, and 157b and the ohmic contacts 163a, 163b, 165a, 165b, and 167b are also slanted with respect to the surface of the substrate 100, at an angle in a range of about 30° to about 80°.

A plurality of data conductors including a plurality of data lines 171 and a plurality of pairs of first and second drain electrodes 175a and 175b are formed on the ohmic contacts 163a, 163b, 165a, 165b, and 167b and the gate insulating layer 140.

Data lines 171 for transmitting data signals mainly extend in the longitudinal direction to intersect gate lines 121a and 121b and storage electrode lines 131. Data lines 171 include a plurality of first and second source electrodes 173a and 173b that protrude toward the first and second gate electrodes 124a and 124b, and end portions 179 that have wide areas for connection to other layers or external driver circuits.

The first and second drain electrodes 175a and 175b are separated from each other, and are also separated from the data line 171.

The first drain electrode 175a includes a bar-shaped end portion 176a that faces the first source electrode 173a with respect to the gate electrode 124a interposed therebetween, an expansion portion 177a that has a shape of a wide rectangle at the one end thereof opposite to the bar-shaped end portion 176a, and a line-shaped connection portion 176aa that connects the expansion portion 177a and the end portion 176a. The extension portion 177a overlaps the storage electrode 137. The bar-shaped end portion 176a overlaps the first gate electrode 124a and is partially surrounded by the U-shaped first source electrode 173a.

The connection portion 176aa of the first drain electrode 175a is mostly located on the extension portion 139, and extends along the extension portion 139 and is located within a longitudinal boundary line of the extension portion 139.

Similarly, the second drain electrode 175b includes a bar-shaped end portion 176b that faces the second source electrode 173b with respect to the gate electrode 124b interposed therebetween, an expansion portion 177b that has a shape of a wide rectangle at the one end thereof opposite to the bar-shaped end portion 176b, and a line-shaped connection portion 176ab that connects the expansion portion 177b and the end portion 176b. The extension portion 177b overlaps the storage electrode 137. The bar-shaped end portion 176b overlaps the second gate electrode 124b and is partially surrounded by the U-shaped second source electrode 173b. The area of the expansion portion 177b of the second drain electrode 175b is smaller than that of the expansion portion 177a of the first drain electrode 175a.

The storage capacitance can be increased by providing the extension portion 139 under the connection portion 176aa of the first drain electrode 175a. Accordingly, the area of the storage electrode 137 can be reduced, to thereby increase the aperture ratio of the liquid crystal display.

The first (second) gate electrode 124a (124b), the first (second) source electrode 173a (173b), and the first (second) drain electrode 175a (175b) together with the first (second) semiconductor member 154a (154b) constitutes a first (second) thin film transistor Qa (Qb). The channel of the first (second) thin film transistor Qa (Qb) is formed in the first (second) semiconductor member 154a (154b) between the first (second) source electrode 173a (173b) and the first (second) drain electrode 175a (175b).

Side surfaces of the data conductors 171, 175a, and 175b may also be slanted with respect to the surface of substrate 110 at an angle ranging from about 30° to about 80°.

The ohmic contacts 163a, 163b, 165a, 165b, and 167b are interposed only between the underlying semiconductor members 154a, 154b, and 157b and the overlying data conductors 171, 175a, and 175b, and reduce contact resistance therebetween. The semiconductor members 156, 157a, and 157b disposed on gate lines 121a and 121b and storage electrode lines 131 allow the profile of surfaces to be smoothed, so that disconnection of data lines 171 and drain electrodes 175a and 175b can be prevented. The island-shaped semiconductor members 154a and 154b have exposed portions that do not cover regions between the source electrodes 173a and 173b and drain electrodes 175a and 175b and the data conductors 171, 175a, and 165b.

A passivation layer 180 is formed on the data conductors 171, 175a, and 175b and the exposed portions of the semiconductor members 154a and 154b. Passivation layer 180 is made of an inorganic insulating material or an organic insulating material, and a surface thereof may be planarized. A plurality of contact holes 182, 185a, and 185b that expose the end portions 179 of data lines 171 and the expansion portions 177a and 177b of drain electrodes 175a and 175b, respectively, are formed on the protective layer 180. A plurality of contact holes 181a and 181b that expose end portions 129a and 129b of gate lines 121a and 121b are formed on the protective layer 180 and the gate insulating layer 140.

A plurality of pixel electrodes 191 including first and second sub-pixel electrodes 191a and 191b and a plurality of contact assistants 81a, 81 b, and 82 are formed on the protective layer 180. The components may be made of a transparent conductive material such as ITO and IZO, or a reflective metal such as aluminum (Al), silver (Ag), chromium (Cr), and alloys thereof.

Each pixel electrode 191 has a shape of an approximate rectangle having four chamfered corners forming angles of about 45° with respect to gate lines 121a and 121b.

A pair of the first and second sub-pixel electrodes 191a and 191b constituting the pixel electrode 191 are engaged with each other with gaps 92 and 93 interposed therebetween. The second sub-pixel electrode 191b has a shape of an isosceles trapezoid of which base is recessed in a shape of a trapezoid. Moreover, most portions of the second sub-pixel electrode 191b are surrounded by the first sub-pixel electrode 191a. The first sub-pixel electrode 191a includes upper, lower, and central trapezoids that are connected to each other at the left side.

Each pixel electrode 191 has a pair of first primary edges 193 and 194 facing each other and second primary edges that are connected to the first primary edges 193 and 194 and include a plurality of sawteeth 90 and lower edges 90c connecting the sawteeth 90. Each of the sawteeth 90 includes first and second slanted edges 90a and 90d that are slanted with respect to the first primary edges 193 and 194, and an upper edge 90b. The first primary edges 193 and 194 are parallel to gate lines 121. The first primary edges 193 and 194 and the second primary edges constitute an approximate rectangle. The pixel electrode 191 has the four chamfered corners forming angles of about 45° with respect to gate lines 121. The first slanted edge 90a partially overlaps the data line 171. The first slanted edges 90a of the adjacent two pixel electrodes 191 are disposed to face each other in parallel to each other.

The first sub-pixel electrode 191a includes cutouts 94a and 94b that extend from an upper side of an upper trapezoid and a lower side of a lower trapezoid toward the right side thereof, respectively. A central trapezoid of the first sub-pixel electrode 191a is inserted into a receded lower side of the second sub-pixel electrode 191b. In addition, the first sub-pixel electrode 191a includes a central cutout 91 that has a transverse portion and a pair of slanted portions connected thereto. The transverse portion extends shortly along a transverse central line of the first sub-pixel electrode 191a. A pair of the slanted portions extend from the transverse portion toward the left side of the first sub-pixel electrode 191a with an angle of 45° with respect to the storage electrode line 131. The gaps 92 and 93 between the first and second sub-pixel electrodes 191a and 191b include two pairs of upper and lower slanted portions and a longitudinal portion that form an angle of about 45° with respect to gate lines 121a and 121b. Hereinafter, for convenience of description, the gaps 92 and 93 are referred to as cutouts. The cutouts 91 to 94b have an inversion type of symmetry with respect to the storage electrode line 131. The cutouts 91 to 94b extend perpendicularly to each other with slanted angles of about 45° with respect to gate lines 121a and 121b. Each pixel electrode 191 is divided into a plurality of partitions by the cutouts 91 to 94b.

Accordingly, the upper and lower half regions with respect to the storage electrode line 131 bisecting the pixel electrode 191 in the transverse direction are divided into four partitions by the cutouts 91 to 94b.

The number of partitions and the number of cutouts may vary according to design factors such as the size of the pixel electrode 191, the ratio of lengths of the transverse and longitudinal sides of the pixel electrode 191, and the types or characteristics of the liquid crystal layer 3.

The first and second sub-pixel electrodes 191a and 191b are connected to the first and second drain electrodes 175a and 175b through the contact holes 185a and 185b, and have data voltages applied thereto from the first and second drain electrodes 175a and 175b. A pair of the sub-pixel electrodes 191a and 191b have different predetermined data voltages for one input image signal applied thereto. The sizes of the data voltages may be determined according to the areas and shapes of the sub-pixel electrodes 191a and 191b. In addition, the areas of the sub-pixel electrodes 191a and 191b may be different from each other. As an example, the second sub-pixel electrode 191b may have a higher voltage applied thereto than that applied to the first sub-pixel electrode 191a, and the area of the second sub-pixel electrode 191b may be smaller than that of the first sub-pixel electrode 191a.

The sub-pixel electrodes 191a and 191b that have the data voltages applied thereto and the common electrode 270 that has the common voltage applied thereto constitute first and second liquid crystal capacitors that sustain the applied voltages after the thin film transistor turns off. Each of the liquid crystal capacitors includes a corresponding portion of the liquid crystal layer 3 as the dielectric member.

The first and second sub-pixel electrodes 191a and 191b and the expansion portions 177a and 177b of the drain electrodes 173a and 173b electrically connected thereto overlap the storage electrode 137, the extension portion 139, and the storage electrode line 131 so as to constitute a storage capacitor for strengthening a voltage storage capacity of the liquid crystal capacitor.

The contact assistants 81a, 81 b, and 82 are connected to the end portions 129a and 129b of gate lines 121a and 121b and the end portion 179 of the data line 171 through the contact holes 181a, 181 b, and 182, respectively.

Now, the common electrode panel 200 will be described in detail.

A light blocking member 220 is formed on the insulating substrate 210 made of transparent glass or a plastic material. The light blocking member 220 includes line-shaped portions corresponding to data lines 171, enlarged portions formed by enlarging some portions of the light blocking member 220, and plane-shaped portions corresponding to the thin film transistors. The light blocking member 220 prevents light leakage between pixel electrodes 191 and defines opening regions facing the pixel electrodes. However, the light blocking member 220 may further include a plurality of opening portions facing pixel electrodes 191 and having substantially the same shape as pixel electrodes 191.

A plurality of color filters 230 are formed on the substrate 210. Most portions of the color filters 230 are disposed in regions surrounded by the light-blocking member 220. In addition, the color filters 230 extend along rows of pixel electrodes 191 in the longitudinal direction. Each of the color filters 230 can display one of primary colors such as red, green, and blue.

An overcoat 250 is formed on the color filters 230 and the light-blocking member 220. The overcoat 250 may be made of an (e.g., organic) insulating material. The overcoat 250 prevents the color filters 230 from being exposed and provides a planarized surface. The overcoat 250 may be omitted.

A common electrode 270 is formed on the cover film 250. The common electrode 270 is made of a transparent conductive material such as ITO and IZO.

A plurality of slope members 71, 72, 73a, 73b, 74a, 74b, and 75 are formed on the common electrode 270.

One slope member set 71-75 faces one pixel electrode 191, and includes a central slope member 71, first to third lower slanted slope members 72, 73a, and 74a, first to third upper slanted slope members 72, 73b, and 74b, and a connection portion 75. The slope members 71, 72, 73a, 73b, 74a, and 74b are disposed between the adjacent cutouts 91, 92, 93a, 93b, 94a, and 94b of the pixel electrode 191 or between the cutouts 91, 92, 93a, 93b, 94a, and 94b and the chamfered edge of the pixel electrode 191. In addition, each of the slope members 71, 72, 73a, 73b, 74a, and 74b extends substantially in parallel to the lower cutouts 93a and 94a or upper cutouts 93b and 94b of the pixel electrode 191, and include at least one slanted portion.

The first lower and upper slanted slope members 72a and 72b extend substantially from the right side to the left side of the pixel electrode 191. The second lower and upper slanted slope members 73a and 73b extend substantially from the right side to the upper and lower left corners of the pixel electrode 191, respectively. The third lower and upper slanted slope members 74a and 74b extend substantially from the right side to the lower and upper sides of the pixel electrode 191, respectively. The third lower and upper slanted slope members 74a and 74b include terminated transverse portions that extend from the ends of the third lower and upper slanted slope members 74a and 74b to overlap the lower and upper sides of the pixel electrode 191. The terminated transverse portions form an obtuse angle with respect to the slanted cutouts 74a and 74b.

The central slope member 71 includes a central transverse portion and a pair of slanted portions. The central transverse portion extends substantially from the right side of the pixel electrode 191 along the storage electrode line 131 in the leftward direction. A pair of the slanted portions extend substantially in parallel to the lower and upper slope members 72, 73a, 73b, 74a, and 74b from the end of the central transverse portion to the left side of the pixel electrode 191.

One end of the one slanted portion of the central slope member 71 and one end of the second lower slope member 73a of the adjacent pixel electrode are connected with one of the connection portions 75. Also, one end of the other slanted portion of the central slope member 71 and one end of the second upper slope member 73b of the adjacent pixel electrode are connected with one of the connection portions 75. Additionally, one end of the first lower slanted slope member 72a and one end of the third lower slanted slope member 74a of the adjacent pixel electrode are connected with one of the connection portions 75. Moreover, one end of the first upper slanted slope member 72b and one end of the third upper slanted slope member 74b of the adjacent pixel electrode are connected with one of the connection portions 75. The connection portions 75 are parallel to the first slanted edges 90a of the pixel electrode 191 and are located at portions corresponding to the data line 171.

Alignment films 11 and 21 are coated on inner surfaces of the panels 100 and 200, respectively. The alignment films 11 and 21 may be vertically-aligned films.

Polarizers may be disposed on outer surfaces of the panels 100 and 200, respectively. The transmission axes of the two polarizers are perpendicular to each other, and one of the transmission axes may, for example, be parallel to gate lines 121a and 121b. In the case of a reflective liquid crystal display, one of the two polarizers may be omitted.

The liquid crystal display according to the present embodiment may further include phase retardation films for compensating for retardation of the liquid crystal layer 3. The phase retardation films have birefringence and have a function of inversely compensating for the birefringence of the liquid crystal layer 3.

The liquid crystal layer 3 has negative dielectric anisotropy, and the liquid crystal molecules 31 of the liquid crystal layer 3 are aligned so that the major axes thereof are perpendicular to the surfaces of the two panels 100 and 200 when no electric field is applied to the liquid crystal molecules. Therefore, incident light cannot pass through the perpendicular polarizers and is thus blocked.

When a voltage difference between the two ports of the first or second liquid crystal capacitor is generated by applying the common voltage to the common electrode 270 and the data voltage to the pixel electrode 191, an electric field is generated in the liquid crystal layer 3 in a direction substantially perpendicular to the panels 100 and 200. In response to the electric field, the liquid crystal molecules have a tendency to change the major axis direction to be perpendicular to the direction of the electric field. According to the degree of the tilted angle of the liquid crystal molecules, polarization of the light passing through the liquid crystal layer 3 changes. The change in the polarization results in a change in transmittance of the light due to the polarizers, so that an image is displayed on the liquid crystal display.

The tilted angle of the liquid crystal molecules varies according to the strength of the electric filed. If low and high voltages are applied to the first and second sub-pixel electrodes, respectively, the voltage Va of the first liquid crystal capacitor is higher than the voltage Vb of the second liquid crystal capacitor. Therefore, the tilted angles of the liquid crystal molecules in the first and second sub-pixels are different from each other. As a result, the birghtnesses of the two sub-pixel electrodes are different from each other. Accordingly, by adjusting the voltage Va of the first liquid crystal capacitor and the voltage Vb of the second liquid crystal capacitor, the brightness of the image seen from a side of the liquid crystal display can be closest to the brightness of the image seen from a front of the liquid crystal display, thereby improving the side viewing angle.

The tilted angle for the liquid crystal molecules is determined by a horizontal component of the electric field generated from distortion of the electric field by the slope members 71 to 74b, cutouts 91 to 94b of the electric field generating electrodes 191 and 270, and slanted edges of the pixel electrode 191. The horizontal component of the electric field is perpendicular to the edges of the slope members 71 to 74b and the cutouts 91 to 94b and the slanted edges of the pixel electrode 191.

Referring to FIG. 21, one cutout set of the slope members 71 to 74b and the cutouts 91 to 94b divides one pixel electrode 191 into a plurality of sub-areas having two slanted primary edges. Since the tilted directions of the liquid crystal molecules in the sub-areas are determined by the horizontal component of the electric field, the tilted directions of the liquid crystal molecules include roughly four directions. As the liquid crystal molecules 31 can be adjusted to have various tilt angles, the reference viewing angle of the liquid crystal display can be increased.

In addition, by providing the sawteeth to the side of the pixel electrode 191 adjacent to the data line 171, the secondary electric field generated between the adjacent pixel electrodes 191 can control the alignment of the liquid crystal molecules 31 in the sub-areas. Further, by providing the connection portions 75 at the positions corresponding to the regions where the first slanted edges 90a of the adjacent two pixel electrodes 191 face each other, the alignment of the liquid crystal molecules 31 in the sub-areas can be determined.

The shapes and arrangements of the slope members 71 to 74b and the cutout 91 to 94b for determining the tilted directions of the liquid crystal molecules may be modified in various manners.

In addition, if the area of the second sub-pixel electrode 191b applied with a high voltage is designed to be smaller than that of the first sub-pixel electrode 191a, distortion in a side viewing gamma curve can be reduced. For example, if the area ratio of the first and second sub-pixel electrodes 191a and 191b is about 2:1, the side viewing gamma curve is closer to the front viewing gamma curve, so that side visibility can be improved.

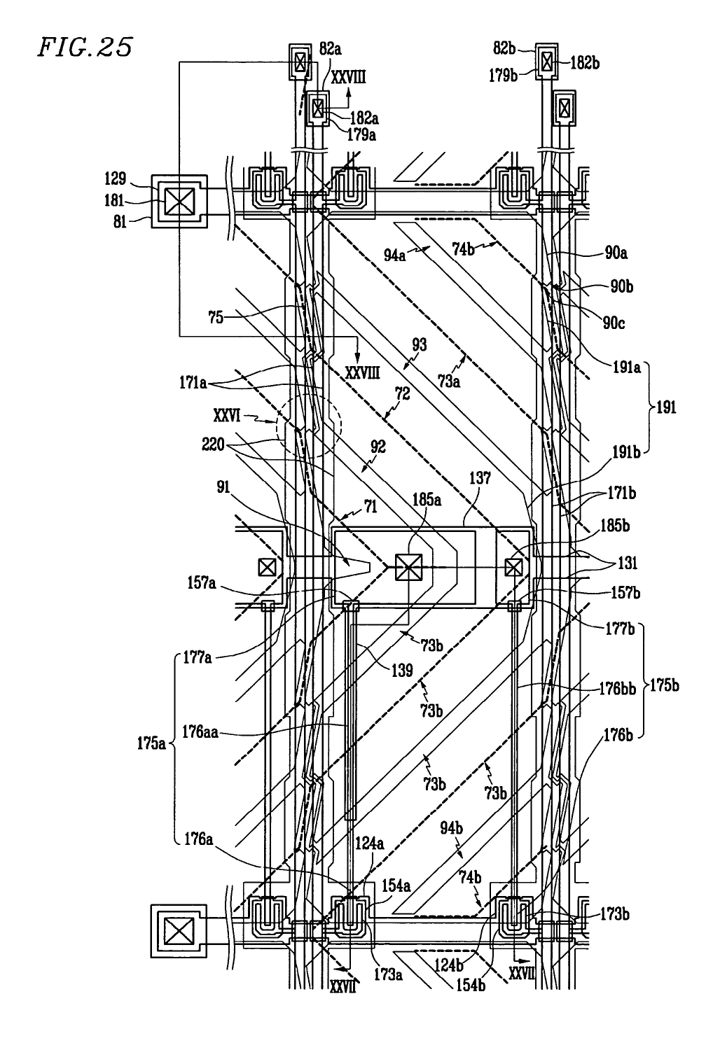

Now, a liquid crystal display according to another exemplary embodiment of the present invention will be described in detail with reference to FIGS. 25 to 28.

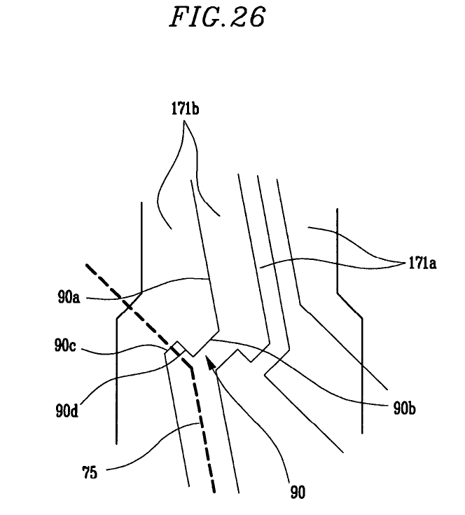

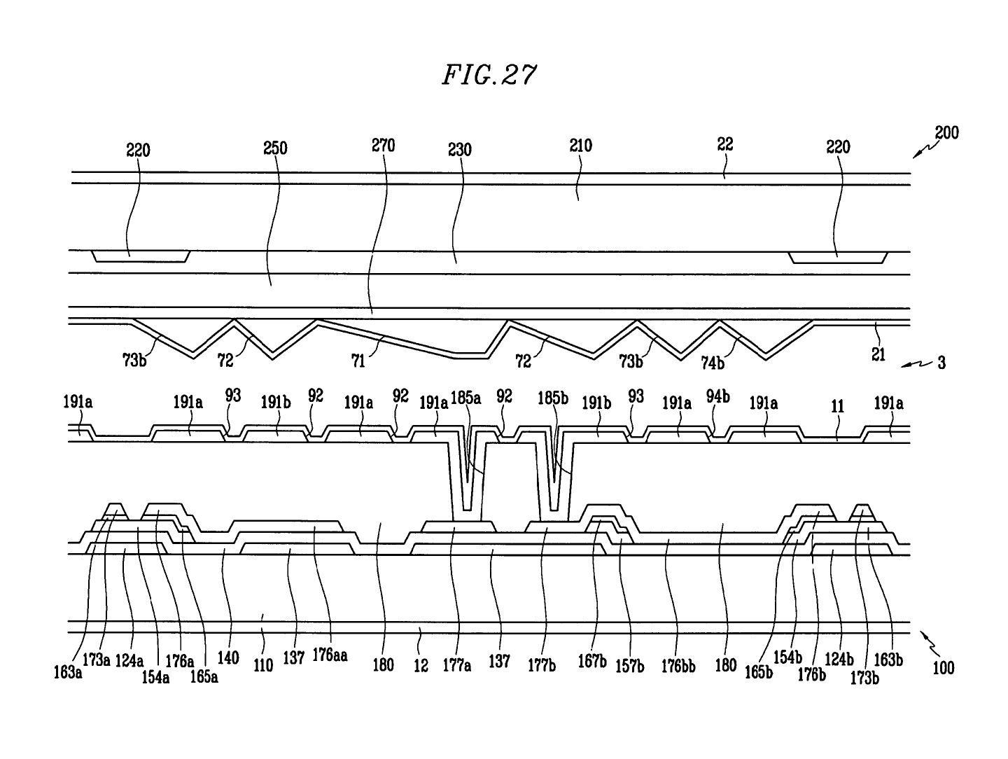

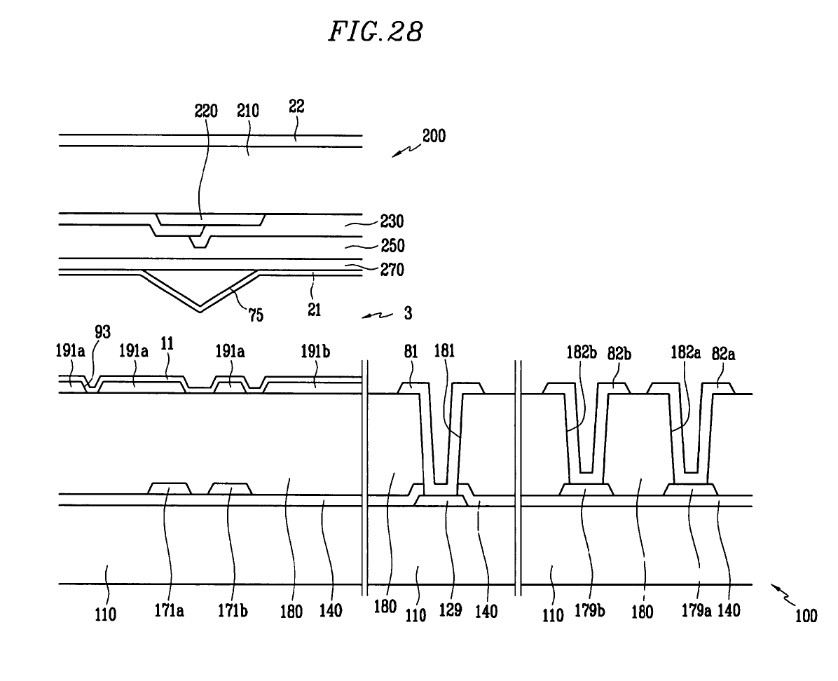

FIG. 25 is a view showing a layout of a liquid crystal display according to an exemplary embodiment of the present invention, FIG. 26 is an enlarged view showing a portion of the liquid crystal display of FIG. 25, FIG. 27 is a cross-sectional view showing the liquid crystal display taken along line XXVII-XXVII of FIG. 25, and FIG. 28 is a cross-sectional view showing the liquid crystal display taken along line XXI-XXX of FIG. 25.

Referring to FIGS. 25 to 28, the liquid crystal display includes a thin film transistor panel 100 and a common electrode panel 200 that face each other, and a liquid crystal layer 3 interposed between the panels 100 and 200.

Firstly, the thin film transistor panel 100 will be described in detail.

A plurality of gate conductors including a plurality of gate lines 121 and a plurality of storage electrode lines 131 are disposed on an insulating substrate 110 made of transparent glass or a plastic material.

Gate lines 121 for transmitting gate signals mainly extend in the transverse direction. Gate lines 121 include first and second gate electrodes 124a and 124b that protrude upwardly and end portions 129 that have wide areas for connection to other layers or external driver circuits.

Storage electrode lines 131 that are applied with predetermined voltages extend substantially in parallel to gate lines 121. Each of storage electrode lines 131 are disposed between two adjacent gate lines 121 and are separated by substantially the same distance from the two gate lines 121. Storage electrode lines 131 include storage electrodes 137 that are enlarged upwardly and downwardly and bar-shaped extension portions 139 that extend from the storage electrodes 137 downwardly. The storage electrodes 137 have a shape of a rectangle and are symmetrically disposed with respect to storage electrode lines 131. The extension portion 139 extends to a portion near the first gate electrode 124a. However, various shapes and arrangement may be used for storage electrode lines 131 and the storage electrodes 137.

A gate insulating layer 140 made of a silicon nitride (SiNₓ) or the like is formed on the gate conductors 121 and 131.

A plurality of island-shaped semiconductor members 154a, 154b, 157a, and 157b made of hydrogenated amorphous silicon or polysilicon are formed on the gate insulating layer 140. The semiconductors 154a and 154b are disposed on the gate electrodes 124a and 124b.

A plurality of island-shaped ohmic contacts 163a, 163b, 165a, 165b, 167a, and 167b are formed on semiconductors 154a, 154b, 157a, and 157b. The ohmic contacts 163a, 163b, 165a, 165b, 167a, and 167b may be made of silicide or n+ hydrogenated amorphous silicon that is heavily doped with n-type impurities such as phosphorus (P). A pair of the ohmic contacts 163a and 163b and a pair of the ohmic contacts 165a and 165b are disposed on the semiconductors 154a and 145b, respectively. A pair of the ohmic contacts 167a and 167b are disposed on the semiconductors 157a and 157b, respectively.

A plurality of data conductors including a plurality of data lines 171a and 171b and a plurality of pairs of first and second drain electrodes 175a and 175b are formed on the ohmic contacts 163a, 163b, 165a, 165b, 167a, and 167b and the gate insulating film 140.

Data lines 171a and 171b for transmitting data signals mainly extend in the longitudinal direction to intersect gate lines 121 and storage electrode lines 131. Data lines 171a and 171b include a plurality of first and second source electrodes 173a and 173b that protrude toward the first and second gate electrodes 124a and 124b, and end portions 179a and 179b that have wide areas for connection to other layers or external driver circuits.

The first and second drain electrodes 175a and 175b are separated from each other and from data lines 171a and 171b. The first and second drain electrodes 175a and 175b face the source electrodes 173a and 173b with respect to the gate electrodes 124a and 124b interposed therebetween. The first and second drain electrodes 175a and 175b include expansion portions 177a and 177b that have a shape of a wide rectangle at the one end thereof, bar-shaped end portions 176a and 176b at the other ends thereof, and connection portions 176aa and 176bb connecting the expansion portions 177a and 177b and the end portions 176a and 176b. The expansion portions 177a and 177b overlap the storage electrode 137. The bar-shaped end portions 176a and 176b overlap the gate electrodes 124a and 124b and are partially surrounded by the U-shaped source electrodes 173a and 173b.

The connection portion 176aa of the first drain electrode 175a is mostly located on the extension portion 139. For example, the connection portion 176aa extends along the extension portion 139 and is located within a longitudinal boundary line of the extension portion 139. The area of the expansion portion 177b of the second drain electrode 175b is smaller than that of the expansion portion 177a of the first drain electrode 175a.

The first (second) gate electrode 124a (124b), the first (second) source electrode 173a (173b), and the first (second) drain electrode 175a (175b) together with the first (second) semiconductor member 154a (154b) constitute a first (second) thin film transistor Qa (Qb). The channel of the first (second) thin film transistor Qa (Qb) is formed in the first (second) semiconductor member 154a (154b) between the first (second) source electrode 173a (173b) and the first (second) drain electrode 175a (175b).

The ohmic contacts 163a, 163b, 165a, 165b, 167a, and 167b are interposed only between the underlying semiconductor members 154a, 154b, 157a, and 157b and the overlying data lines 171a and 171b and drain electrodes 175a and 175b, and have a function of reducing contact resistance therebetween. The island-shaped semiconductor members 154a and 154b have exposed portions do not cover regions between the source electrodes 173a and 173b and drain electrodes 175a and 175b, data lines 171a and 171b, and drain electrodes 175a and 175b.

A protective layer (e.g., a passivation layer) 180 is formed on data lines 171a and 171b, drain electrodes 175a and 175b, and the exposed portions of the semiconductor members 154a and 154b.

A plurality of contact holes 185a, 185b, 182a, and 182b that expose the expansion portions 177a and 177b of drain electrodes 175a and 175b and the end portions 179a and 179b of data lines 171a and 171b, respectively, are formed on the protective layer 180. A plurality of contact holes 181 that expose end portions 129 of gate lines 121 are formed on the protective layer 180 and the gate insulating layer 140.

A plurality of pixel electrodes 191 including first and second sub-pixel electrodes 191a and 191b and a plurality of contact assistants 81, 82a, and 82b are formed on the protective layer 180. The components may be made of a transparent conductive material such as ITO and IZO, or a reflective metal such as aluminum (Al), silver (Ag), chromium (Cr), and alloys thereof.

The pixel electrode 191 has the shape of a rectangle having four chamfered corners that form angles of about 45° with respect to gate lines 121.

A pair of the first and second sub-pixel electrodes 191a and 191b constituting the pixel electrode 191 are engaged with each other with gaps 92 and 93 interposed therebetween. The second sub-pixel electrode 191b has the shape of an isosceles trapezoid of which the base is recessed in the shape of a trapezoid. Also, most portions of the second sub-pixel electrode 191b are surrounded by the first sub-pixel electrode 191a. The first sub-pixel electrode 191a includes upper, lower, and central trapezoids that are connected to each other at the left side.

The pixel electrode 191 has a pair of first primary edges 193 and 194 facing each other and second primary edges that are connected to the first primary edges 193 and 194 and include a plurality of sawteeth 90 and lower edges 90c connecting the sawteeth 90. Each of the sawteeth 90 includes first and second slanted edges 90a and 90d that are slanted with respect to the first primary edges 193 and 194 and an upper edge 90b. The first primary edges 193 and 194 are parallel to gate lines 121. The first primary edges 193 and 194 and the second primary edges constitute an approximate rectangle. The pixel electrode 191 has the four chamfered corners that form angles of about 45° with respect to gate lines 121. The first slanted edge 90a partially overlaps the data line 171. The first slanted edges 90a of two adjacent pixel electrodes 191 are disposed to face each other in parallel to each other.

The first sub-pixel electrode 191a includes cutouts 94a and 94b that extend from an upper side of an upper trapezoid and a lower side of a lower trapezoid toward the right side thereof, respectively. A central trapezoid of the first sub-pixel electrode 191a is inserted into a receded lower side of the second sub-pixel electrode 191b. In addition, the first sub-pixel electrode 191a includes a central cutout 91 that has a transverse portion and a pair of slanted portions connected thereto. The transverse portion extends shortly along a transverse central line of the first sub-pixel electrode 191a. A pair of the slanted portions extend from the transverse portion toward the left side of the first sub-pixel electrode 191a with an angle of about 45° with respect to the storage electrode line 131. The gaps 92 and 93 between the first and second sub-pixel electrodes 191a and 191b include two pairs of upper and lower slanted portions and a longitudinal portion that form an angle of about 45° with respect to gate lines 121.

The cutouts 91 to 94b have inversion symmetry with respect to the storage electrode line 131. The cutouts 91 to 94b extend perpendicularly to each other with slanted angles of about 45° with respect to gate lines 121. Each pixel electrode 191 is divided into a plurality of partitions by the cutouts 91 to 94b.

Accordingly, the upper and lower half regions with respect to the storage electrode line 131 bisecting the pixel electrode 191 in the transverse direction are divided into four partitions by the cutouts 91 to 94b.

The number of partitions and the number of cutouts may vary according to design factors, such as the size of the pixel electrode 191, the ratio of lengths of the transverse and longitudinal sides of the pixel electrode 191, and the types or characteristics of the liquid crystal layer 3.

The first and second sub-pixel electrodes 191a and 191b are connected to the first and second drain electrodes 175a and 175b through the contact holes 185a and 185b and are applied with data voltages from the first and second drain electrodes 175a and 175b. A pair of the sub-pixel electrodes 191a and 191b are applied with different predetermined data voltages for one input image signal. The sizes of the data voltages may be determined according to the areas and shapes of the sub-pixel electrodes 191a and 191b. In addition, the areas of the sub-pixel electrodes 191a and 191b may be different from each other. For example, the second sub-pixel electrode 191b has a higher voltage applied thereto than that applied to the first sub-pixel electrode 191a, and the area of the second sub-pixel electrode 191b may be smaller than that of the first sub-pixel electrode 191a.

The first (second) sub-pixel electrodes 191a (191b) are physically and electrically connected to the first (second) drain electrodes 175a (175b) through the contact holes 185a (185b), and have data voltages applied thereto from the first (second) drain electrodes 175a (175b). A pair of the sub-pixel electrodes 191a and 191b have different predetermined data voltages for one input image signal applied thereto. The sizes of the data voltages may be determined according to, for example, the areas and shapes of the sub-pixel electrodes 191a and 191b. In addition, the areas of the sub-pixel electrodes 191a and 191b may be different from each other. For example, the second sub-pixel electrode 191b may have a higher voltage applied thereto than that applied to the first sub-pixel electrode 191a, and the area of the second sub-pixel electrode 191b may be smaller than that of the first sub-pixel electrode 191a.

The sub-pixel electrodes 191a and 191b having data voltages applied thereto and the common electrode 270 having the common voltage applied thereto constitute first and second liquid crystal capacitors that sustain the applied voltages after the thin film transistor turns off. Each of the liquid crystal capacitors includes a corresponding portion of the liquid crystal layer 3 as the dielectric member.

The first and second sub-pixel electrodes 191a and 191b and the expansion portions 177a and 177b of the drain electrodes 173a and 173b electrically connected thereto overlap the storage electrode 137, the extension portion 139, and the storage electrode line 131 with the gate insulating layer 140 interposed therebetween so as to constitute a storage capacitor for strengthening a voltage storage capacity of the liquid crystal capacitor.

The contact assistants 81, 82a, and 82b are connected to the end portions 129 of gate lines 121 and the end portion 179 of the data line 171 through the contact holes 181, 182a, and 182b, respectively.

Now, the common electrode panel 200 will be described in detail.

A light blocking member 220 is formed on the insulating substrate 210 made of transparent glass or a plastic material. The light blocking member 220 include line-shaped portions corresponding to data lines 171, enlarged portions formed by enlarging some portions of the light blocking member 220, and plane-shaped portions corresponding to the thin film transistors. The light blocking member 220 prevents light leakage between pixel electrodes 191 and defines opening regions facing the pixel electrodes. However, the light blocking member 220 may further include a plurality of opening portions facing pixel electrodes 191 and having substantially the same shape as pixel electrodes 191.

A plurality of color filters 230 are formed on the substrate 210. Most portions of the color filters 230 are disposed in regions surrounded by the light-blocking member 220. Also, the color filters 230 extend along rows of pixel electrodes 191 in the longitudinal direction. Each of the color filters 230 can display one of primary colors such as red, green, and blue.

An overcoat 250 is formed on the color filters 230 and the light-blocking member 220. The overcoat 250 may be made of an (e.g., organic) insulating material. The overcoat 250 prevents the color filters 230 from being exposed and provides a planarized surface. The overcoat 250 may be omitted.

A common electrode 270 is formed on the overcoat 250. The common electrode 270 is made of a transparent conductive material such as ITO and IZO.

A plurality of slope members 71, 72, 73a, 73b, 74a, 74b, and 75 are formed on the common electrode 270.

One slope member set 71-75 faces one pixel electrode 191 and includes a central slope member 71, first to third lower slanted slope members 72, 73a, and 74a, first to third upper slanted slope members 72, 73b, and 74b, and a connection portion 75. The slope members 71, 72, 73a, 73b, 74a, and 74b are disposed between the adjacent cutouts 91, 92, 93a, 93b, 94a, and 94b of the pixel electrode 191 or between the cutouts 91, 92, 93a, 93b, 94a, and 94b and the chamfered edge of the pixel electrode 191. In addition, each of the slope members 71, 72, 73a, 73b, 74a, and 74b extends substantially in parallel to the lower cutouts 92, 93a, and 94a or the upper cutouts 92, 93b, and 94b of the pixel electrode 191, and include at least one slanted portion.

The first lower and upper slanted slope members 72a and 72b extend substantially from the right side to the left side of the pixel electrode 191. The second lower and upper slanted slope members 73a and 73b extend substantially from the right side to the upper and lower left corners of the pixel electrode 191, respectively. The third lower and upper slanted slope members 74a and 74b extend substantially from the right side to the lower and upper sides of the pixel electrode 191, respectively. The third lower and upper slanted slope members 74a and 74b include terminated transverse portions that extend from the ends of the third lower and upper slanted slope members 74a and 74b to overlap the lower and upper sides of the pixel electrode 191. The terminated transverse portions have an obtuse angle with respect to the slanted slope members 74a and 74b.

The central slope member 71 includes a central transverse portion and a pair of slanted portions. The central transverse portion extends substantially from the right side of the pixel electrode 191 along the storage electrode line 131 in the left direction. A pair of the slanted portions extend substantially in parallel to the lower and upper slope members 72, 73a, 73b, 74a, and 74b from the end of the central transverse portion to the left side of the pixel electrode 191.

One end of the one slanted portion of the central slope members 71 and one end of the second lower slope member 73a of the adjacent pixel electrode are connected with one of the connection portions 75. Moreover, one end of the other slanted portion of the central cutout 71 and one end of the second upper cutout 73b of the adjacent pixel electrode are connected with one of the connection portions 75. In addition, one end of the first lower slanted cutout 72 and one end of the third lower slanted cutout 74a of the adjacent pixel electrode are connected with one of the connection portions 75. Also, one end of the first upper slanted cutout 72 and one end of the third upper slanted cutout 74b of the adjacent pixel electrode are connected with one of the connection portions 75. The connection portions 75 are parallel to the first slanted edges 90a of the pixel electrode 191 and are located at portions corresponding to the data line 171.

Alignment films 11 and 21 are coated on inner surfaces of the panels 100 and 200, respectively. The alignment films 11 and 21 may be a vertically-aligned film. Polarizers may be disposed on outer surfaces of the panels 100 and 200, respectively. The transmission axes of the two polarizers are perpendicular to each other, and one of the transmission axes may, for example, be parallel to gate lines 121a and 121b. In the case of a reflective liquid crystal display, one of the two polarizers may be omitted.

The liquid crystal display according to the present embodiment may further include a phase retardation film for compensating for retardation of the liquid crystal layer 3. The phase retardation film has birefringence and has a function of inversely compensating for the birefringence of the liquid crystal layer 3.

The liquid crystal layer 3 has a negative dielectric anisotropy, and the liquid crystal molecules 31 of the liquid crystal layer 3 are aligned so that the major axes thereof are perpendicular to the surfaces of the two panels 100 and 200 when no electric field is applied to the liquid crystal molecules. Therefore, incident light cannot pass through the perpendicular polarizers and is thus blocked.

In addition, by providing the sawteeth to the side of the pixel electrode 191 adjacent to the data line 171, the secondary electric field generated between the adjacent pixel electrodes 191 can control the alignment of the liquid crystal molecules 31 in the sub-areas. Further, by providing the connection portions 75 at the positions corresponding to the regions where the first slanted edges 90a of two adjacent pixel electrodes 191 face each other, the alignment of the liquid crystal molecules 31 in the sub-areas can also be controlled.

According to a liquid crystal display of the exemplary embodiments of the present invention, longitudinal cutouts of a common electrode are removed, so that the removed areas can be used as light transmitting areas. In addition, since connection portions corresponding to gaps between the pixel electrodes are provided to the common electrode, alignment of liquid crystal molecules in sub-pixel areas can be controlled due to secondary electric fields, thereby reducing texture and improving the aperture ratio and transmittance of the liquid crystal displays.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display, comprising:
a plurality of pixel electrodes;
a common electrode facing the pixel electrodes;
a liquid crystal display formed between the pixel electrodes and the common electrode; and
a plurality of slope members formed on the common electrode and having a ridge and an inclined surface,
wherein the slope members include a plurality of pixel slope members facing the pixel electrodes and a plurality of connection slope members for connecting the neighboring pixel slope members.

2. The liquid crystal display of claim 1, wherein the pixel electrodes have a pair of first primary edges facing each other and a pair of second primary edges connected to the first primary edges and facing each other, and the second primary edges comprise a plurality of protrusions of a sawtooth shape.

3. The liquid crystal display of claim 2, wherein the connection slope members face the gap between the neighboring pixel electrodes.

4. The liquid crystal display of claim 3, further comprising:
a plurality of gate lines;
a plurality of data lines intersecting the gate lines; and
a plurality of thin film transistors connected to the gate lines and the data lines,
wherein the pixel electrodes are connected to the thin film transistors.

5. The liquid crystal display of claim 4, wherein the pixel slope members form an oblique angle with respect to the gate lines.

6. The liquid crystal display of claim 2, wherein the pixel electrodes comprise a plurality of cutouts that have a slanted angle with respect to the first primary edges.

7. The liquid crystal display of claim 6, wherein each of the protrusions comprise a first edge that has an angle of one of about 135° or more or about 45° or less with respect to the cutouts.

8. The liquid crystal display of claim 6, wherein each of the protrusions further comprises a second edge that is parallel to the cutouts.

9. The liquid crystal display of claim 8, wherein the second edge is located on the extension line of the edge of the cutouts.

10. The liquid crystal display of claim 6, wherein an envelope of the protrusions and the first primary edges constitutes a rectangle.

11. The liquid crystal display of claim 10, wherein at least one of corners of the rectangle has a chamfered slanted edge.

12. The liquid crystal display of claim 11, wherein the chamfered slanted edge of the rectangle has an angle of about 45° with respect to the first primary edges.

13. The liquid crystal display of claim 6, wherein the protrusions overlap the data lines.

14. The liquid crystal display of claim 1, wherein protrusions of adjacent second primary edges of adjacent pixel electrodes are engaged with each other.

15. The liquid crystal display of claim 1, wherein facing edges of protrusions that are disposed to be engaged with each other are parallel to each other.

16. The liquid crystal display of claim 6, wherein each of the pixel electrodes includes at least two sub-pixel electrodes that are physically separated from each other by a cutout.

17. The liquid crystal display of claim 16, wherein voltages of at least two sub-pixel electrodes are different from each other.

18. The liquid crystal display of claim 17, wherein at least two sub-pixel electrodes are capacitively coupled.

19. The liquid crystal display of claim 16, wherein the sub-pixel electrodes are respectively connected to thin film transistors.

20. The liquid crystal display of claim 16, wherein the sub-pixel electrodes of one pixel electrode are connected to different data lines, and the sub-pixel electrodes of one pixel electrode are connected to the same gate line.

21. The liquid crystal display of claim 16, wherein the sub-pixel electrodes of one pixel electrode are connected to different gate lines, and the sub-pixel electrodes of one pixel electrode are connected to the same data line.

22. The liquid crystal display of claim 1, wherein an inclination angle of the inclined surfaces is in a range of about 1 to 10 degrees.

23. The liquid crystal display of claim 1, wherein the inclined surfaces are curved.

24. The liquid crystal display of claim 1, wherein the thickness of the slope members is in the range of about 0.5-2.0 microns.

25. The liquid crystal display of claim 1, further comprising a plurality of color filters under the common electrode.

26. The liquid crystal display of claim 25, further comprising an overcoat formed between the common electrode and the color filters.

27. The liquid crystal display of claim 26, wherein the slope members are formed between the common electrode and the overcoat.

28. The liquid crystal display of claim 26, wherein the slope members and the overcoat are formed of one body.
